(19) United States
(12) Patent Application Publication
(10) Pub. No.: US 2025/0048485 A1
(43) Pub. Date: Feb. 6, 2025

(54) MULTIPLEXING FOR MBS OR SDT

(71) Applicant: QUALCOMM Incorporated, San Diego, CA (US)

(72) Inventors: Jing LEI, San Diego, CA (US); Ruiming ZHENG, Beijing (CN); Peter GAAL, San Diego, CA (US)

(21) Appl. No.: 18/718,369

(22) PCT Filed: Feb. 8, 2023
(86) PCT No.: PCT/CN2023/074906

§ 371 Date: Jun. 10, 2024

(30) Foreign Application Priority Data
Feb. 8, 2022 (WO) PCT/CN2022/075473

(51) Int. Cl. H04W 76/27; H04W 76/40

(52) U.S. Cl. CPC H04W 76/27; H04W 76/40

(57) ABSTRACT

Methods, apparatuses, and computer-readable storage medium for supporting mobile-originated small data transmission (MO-SDT) and mobile-terminated small data transmission (MT-SDT) or point-to-multi-point (P2M) multicast and broadcast services (MBS) are provided. An example method may include transmitting, to a base station, a capability indication representing support of MO-SDT and MT-SDT. The example method may further include receiving, from the base station, one or more configurations for the MO-SDT and the MT-SDT in a radio resource control (RRC) message, the RRC message comprising at least an RRC release message. The example method may further include transitioning to an RRC inactive state. The example method may further include transmitting, to the base station, a common control channel (CCCH) message in a MO-SDT transmission while in the RRC inactive state.

### CROSS REFERENCE TO RELATED APPLICATION(S)

This application claims the benefit of and priority to international application Serial No. PCT/CN2022/075473, entitled “MULTIPLEXING FOR MBS OR SDT” and filed on Feb. 8, 2022, which is expressly incorporated by reference herein in its entirety.

### TECHNICAL FIELD

The present disclosure relates generally to communication systems, and more particularly, to wireless communication systems with small data transfer (SDT) such as mobile-originated small data transmission (MO-SDT) or mobile-terminated small data transmission (MT-SDT) or point-to-multi-point (P2M) or peer to peer (P2P) multicast and broadcast services (MBS).

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (cMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include a memory and at least one processor coupled to the memory configured to transmit, to a network entity, a capability indication representing support of MO-SDT and MT-SDT. The at least one processor coupled to the memory may be further configured to receive, from the network entity, one or more configurations for the MO-SDT and the MT-SDT in a radio resource control (RRC) message, the RRC message comprising at least an RRC release message. The at least one processor coupled to the memory may be further configured to transition to an RRC inactive state. The at least one processor coupled to the memory may be further configured to transmit, to the network entity, a common control channel (CCCH) message in a MO-SDT transmission while in the RRC inactive state.

In another aspect of the disclosure, a method, a computer-readable medium, and an apparatus at a UE are provided. The apparatus may include a memory and at least one processor coupled to the memory configured to transmit, to a network entity, a capability indication representing support of SDT and P2M MBS. The at least one processor coupled to the memory may be further configured to receive, from the network entity, one or more configurations for the SDT and the P2M MBS. The at least one processor coupled to the memory may be further configured to transition to an RRC inactive state. The at least one processor coupled to the memory may be further configured to transmit, to the network entity, a CCCH message via MO-SDT while in the RRC inactive state.

In another aspect of the disclosure, a method, a computer-readable medium, and an apparatus at a network entity are provided. The apparatus may include a memory and at least one processor coupled to the memory configured to receive, from a UE, a capability indication representing support of MO-SDT and MT-SDT. The at least one processor coupled to the memory may be further configured to transmit, to the UE, one or more configurations for the MO-SDT and the MT-SDT in an RRC message, the RRC message comprising at least an RRC release message. The at least one processor coupled to the memory may be further configured to receive, from the UE, a CCCH message in a MO-SDT transmission while in the RRC inactive state.

In another aspect of the disclosure, a method, a computer-readable medium, and an apparatus at a network entity are provided. The apparatus may include a memory and at least one processor coupled to the memory configured to receive, from a UE, a capability indication representing support of SDT and P2M CBS. The at least one processor coupled to the memory may be further configured to transmit, to the UE, one or more configurations for the SDT and the P2M MBS. The at least one processor coupled to the memory may be further configured to receive, from the UE, a CCCH message via MO-SDT while in the RRC inactive state.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network, in accordance with various aspects of the present disclosure.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network, in accordance with various aspects of the present disclosure.

FIG. 4 is a diagram illustrating an example configured grant (CG) SDT that may be mobile-originated (MO).

FIG. 5 is a diagram illustrating an example RA-SDT that may be MO and may be used in conjunction with a 2-step RACH procedure.

FIG. 6 is a diagram illustrating an example RA-SDT that may be MO and may be used in conjunction with a 4-step RACH procedure.

FIG. 7 is a diagram illustrating example MT-SDT that may be Msg 4 based.

FIG. 8 is a diagram illustrating an example common frequency resource (CFR).

FIG. 9A is a diagram illustrating joint support of MO-SDT and MT-SDT, in accordance with various aspects of the present disclosure.

FIG. 9B is a diagram illustrating joint support of MO-SDT and MT-SDT in radio resource control (RRC) inactive state, in accordance with various aspects of the present disclosure.

FIG. 10 is a diagram illustrating joint support of SDT and MBS, in accordance with various aspects of the present disclosure.

FIGS. 11A-C are diagrams illustrating example resource configurations of SDT and MBS, in accordance with various aspects of the present disclosure.

FIG. 12 is a flowchart of a method of wireless communication, in accordance with various aspects of the present disclosure.

FIG. 13 is a flowchart of a method of wireless communication, in accordance with various aspects of the present disclosure.

FIG. 14 is a flowchart of a method of wireless communication, in accordance with various aspects of the present disclosure.

FIG. 15 is a flowchart of a method of wireless communication, in accordance with various aspects of the present disclosure.

FIG. 16 is a flowchart of a method of wireless communication, in accordance with various aspects of the present disclosure.

FIG. 17 is a flowchart of a method of wireless communication, in accordance with various aspects of the present disclosure.

FIG. 18 is a diagram illustrating an example of a hardware implementation for an example apparatus, in accordance with various aspects of the present disclosure.

FIG. 19 is a diagram illustrating an example of a hardware implementation for an example apparatus, in accordance with various aspects of the present disclosure.

FIG. 20 shows a diagram illustrating an example disaggregated base station architecture.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Aspects described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described aspects may occur. Implementations may range a spectrum from chip-level or modular components to non-modular, non-chip-level implementations and further to aggregate, distributed, or original equipment manufacturer (OEM) devices or systems incorporating one or more aspects of the described aspects. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that aspects described herein may be practiced in a wide variety of devices, chip-level components, systems, distributed arrangements, aggregated or disaggregated components, end-user devices, etc. of varying sizes, shapes, and constitution.

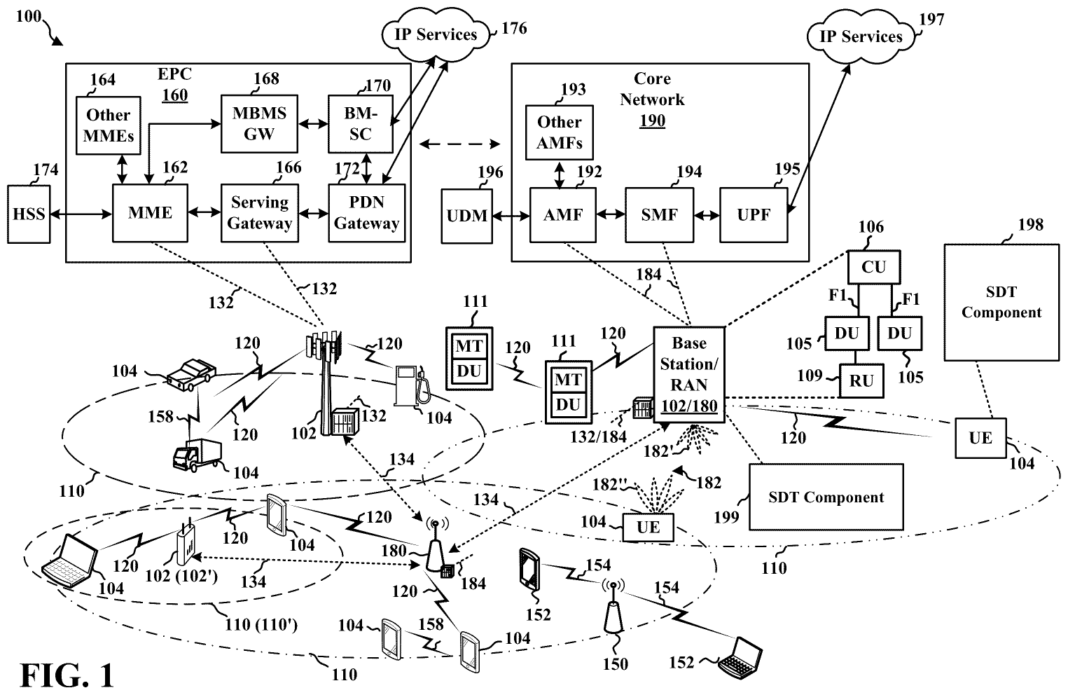

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184 (e.g., an Xn interface), and the third backhaul links 134 may be wired or wireless.

In some aspects, a base station 102 or 180 may be referred as a RAN and may include aggregated or disaggregated components. As an example of a disaggregated RAN, a base station may include a central unit (CU) 106, one or more distributed units (DU) 105, and/or one or more remote units (RU) 109, as illustrated in FIG. 1. A RAN may be disaggregated with a split between an RU 109 and an aggregated CU/DU. A RAN may be disaggregated with a split between the CU 106, the DU 105, and the RU 109. A RAN may be disaggregated with a split between the CU 106 and an aggregated DU/RU. The CU 106 and the one or more DUs 105 may be connected via an F1 interface. A DU 105 and an RU 109 may be connected via a fronthaul interface. A connection between the CU 106 and a DU 105 may be referred to as a midhaul, and a connection between a DU 105 and an RU 109 may be referred to as a fronthaul. The connection between the CU 106 and the core network may be referred to as the backhaul. The RAN may be based on a functional split between various components of the RAN, e.g., between the CU 106, the DU 105, or the RU 109. The CU may be configured to perform one or more aspects of a wireless communication protocol, e.g., handling one or more layers of a protocol stack, and the DU(s) may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. A CU 106 may host higher layer functions, e.g., above the RLC layer, such as a service data adaptation protocol (SDAP) layer, a packet data convergence protocol (PDCP) layer. In other implementations, the split between the layer functions provided by the CU, DU, or RU may be different.

An access network may include one or more integrated access and backhaul (IAB) nodes 111 that exchange wireless communication with a UE 104 or other IAB node 111 to provide access and backhaul to a core network. In an IAB network of multiple IAB nodes, an anchor node may be referred to as an IAB donor. The IAB donor may be a base station 102 or 180 that provides access to a core network 190 or EPC 160 and/or control to one or more IAB nodes 111. The IAB donor may include a CU 106 and a DU 105. IAB nodes 111 may include a DU 105 and a mobile termination (MT). The DU 105 of an IAB node 111 may operate as a parent node, and the MT may operate as a child node.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (cNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the Referring again to FIG. 1, in some aspects, the UE 104 may include an SDT component 198. In some aspects, the SDT component 198 may transmit, to a network entity, a capability indication representing support of MO-SDT and MT-SDT. In some aspects, the SDT component 198 may receive, from the network entity, one or more configurations for the MO-SDT and the MT-SDT in an RRC message, the RRC message comprising at least an RRC release message. In some aspects, the SDT component 198 may transition to an RRC inactive state. In some aspects, the SDT component 198 may transmit, to the network entity, a CCCH message in a MO-SDT transmission while in the RRC inactive state.

In some aspects, a network entity may be implemented as a base station (i.e., an aggregated base station), or alternatively, as a central unit (CU), a distributed unit (DU), a radio unit (RU), a Near-Real Time (Near-RT) RAN Intelligent Controller (RIC), or a Non-Real Time (Non-RT) RIC in a disaggregated base station architecture.

In some aspects, the SDT component 198 may transmit, to a network entity, a capability indication representing support of SDT and P2M CBS. In some aspects, the SDT component 198 may receive, from the network entity, one or more configurations for the SDT and the P2M MBS. In some aspects, the SDT component 198 may transition to an RRC inactive state. In some aspects, the SDT component 198 may transmit, to the network entity, a CCCH message via MO-SDT while in the RRC inactive state.

In some aspects, the base station 102/180 or another network entity such as the DU 105, or the RU 109 may include an SDT component 199. In some aspects, the SDT component 199 may receive, from a UE, a capability indication representing support of MO-SDT and MT-SDT. In some aspects, the SDT component 199 may transmit, to the UE, one or more configurations for the MO-SDT and the MT-SDT in an RRC message, the RRC message comprising at least an RRC release message. In some aspects, the SDT component 199 may receive, from the UE, a CCCH message in a MO-SDT transmission while in the RRC inactive state.

In some aspects, the SDT component 199 may receive, from a UE, a capability indication representing support of SDT and P2M CBS. In some aspects, the SDT component 199 may transmit, to the UE, one or more configurations for the SDT and the P2M MBS. In some aspects, the SDT component 199 may receive, from the UE, a CCCH message via MO-SDT while in the RRC inactive state.

Although the following description may be focused on 5G NR, the concepts described herein may be applicable to other similar areas, such as LTE, LTE-A, CDMA, GSM, and other wireless technologies.

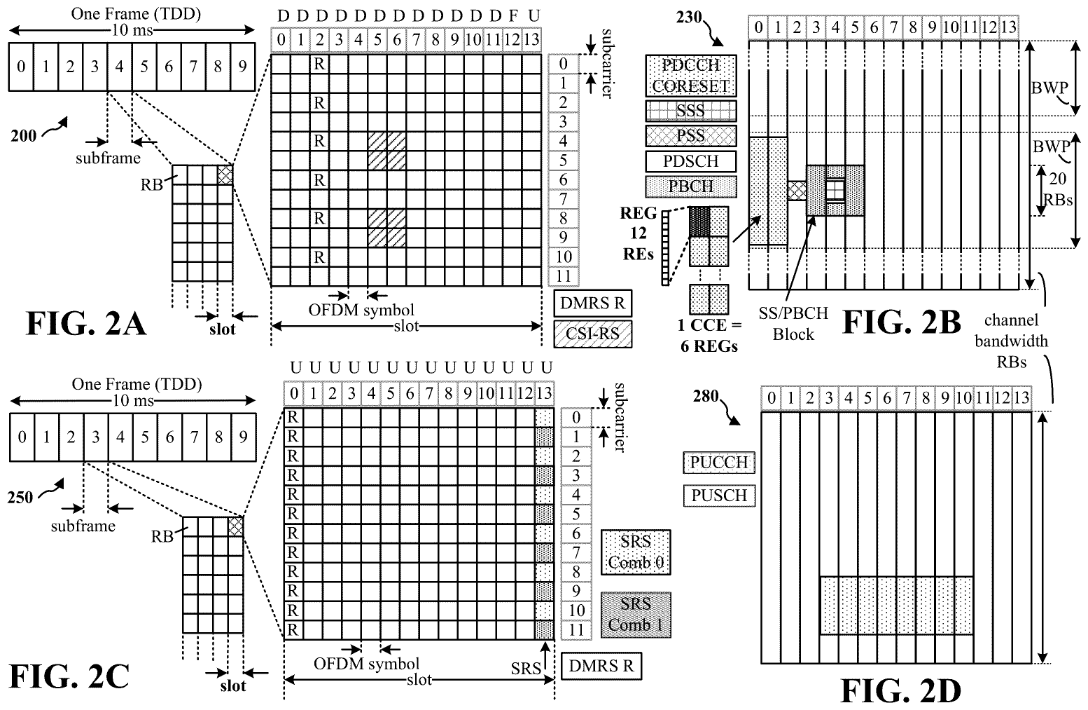

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

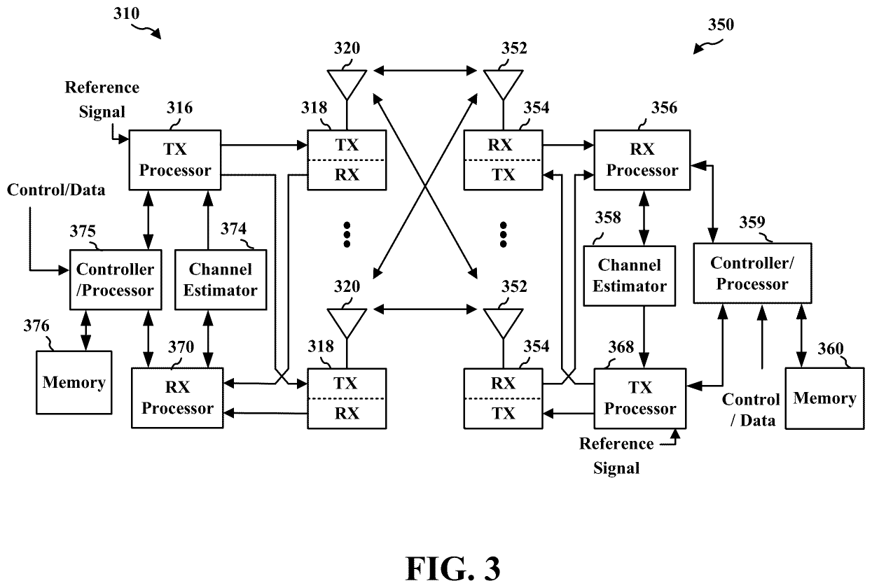

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter, e.g., 318 TX. Each transmitter, e.g., 318 TX, may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters, e.g., 354 TX. Each transmitter, e.g., 354 TX, may modulate an RF carrier with a respective spatial stream for transmission.

The UL transmission is processed at the base station 310 in a manner similar to that described in connection with the receiver function at the UE 350. Each receiver 318 RX receives a signal through its respective antenna 320. Each receiver 318 RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with SDT component 198 of FIG. 1.

At least one of the TX processor 316, the RX processor 370, and the controller/processor 375 may be configured to perform aspects in connection with SDT component 199 of FIG. 1.

In some wireless communication systems, an RRC protocol may be used on the air interface. Functions of the RRC protocol may include connection establishment and release functions, broadcast of system information, radio bearer establishment, reconfiguration and release, RRC connection mobility procedures, paging notification and release and outer loop power control, among other aspects. The RRC protocol may configure user and control planes according to the network status and may allow for radio resource management strategies to be implemented. Some example services and functions of an RRC layer/sublayer may include broadcast of system information related to access stratum (AS) or non-access stratum (NAS), paging, establishment and release of an RRC connection between a UE and a radio access network (RAN), establishment and release of signaling radio bearers (SRBs) or data radio bearers (DRBs), mobility functions, or the like. Operations of the RRC may be based on specific states that a UE may be in. In some wireless communication systems, a UE may be in an RRC idle state, an RRC inactive state, or an RRC active state.

The UE may enter an RRC idle state after powering up and before establishing an RRC connection. The UE may also enter the RRC idle state after a connection failure or an RRC release in the RRC connected state or the RRC inactive state. In the RRC idle state, a UE may be able to perform or process public land mobile network (PLMN) selection, broadcast of system information (SI), cell reselection mobility, paging for mobile terminated (MT) data, or discontinuous reception (DRX) for core network paging (CN) configured by NAS. In the RRC inactive state, the UE may be able to perform or process broadcast of SI, cell reselection mobility, RAN paging, RAN based notification area (RNA), DRX for RAN paging, RAN connections in control or user plane, or the like. In the RRC inactive state, the UE's AS context may be stored in RAN and the UE and the RAN may be aware of an RNA in which the UE belongs to. In the RRC connected mode, in addition to being able to perform or process RAN connections, the UE may also transmit or receive unicast data from the RAN and network controlled mobility including measurements may also be processed or performed.

In the RRC inactive state, a UE may identify small amounts of UL data for transmission that may be infrequent or unexpected (e.g., data related to instant messaging services, push notifications, or wearable devices). To transmit the UL data, a UE may perform a random access channel (RACH) procedure and establish an RRC connection with the network and enter an RRC connected state. However, performing a RACH procedure and establishing an RRC connection for small amounts of data may be inefficient in view of the larger signaling overhead compared with the smaller amount of data to be transmitted. Therefore, in some wireless communication systems, a UE in an RRC inactive state may be able to use an SDT procedure to transmit data of volume below a threshold without transitioning to or entering an RRC connected state, e.g., while remaining in the RRC inactive state.

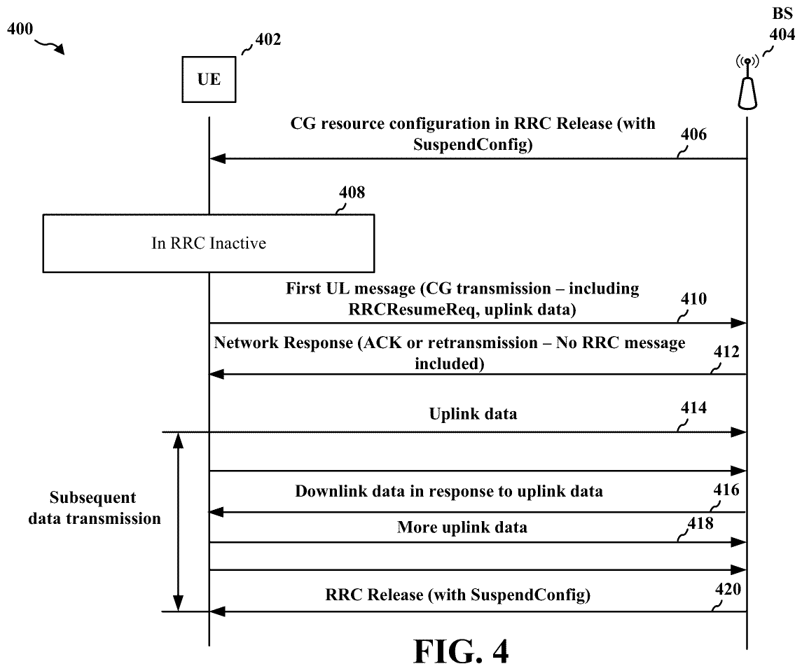

FIG. 4 is a diagram 400 illustrating an example configured grant (CG) SDT that may be mobile-originated (MO). As illustrated in FIG. 4, the base station 404 may transmit a CG resource configuration 406 in an RRC release message. The CG resource configuration 406 in the RRC release message may be associated with a suspend configuration, such as a SuspendConfig information element (IE). The suspend configuration may provide may provide information to the UE 402, such as an RNA update, paging cycle, or the like. The CG resource configuration 406 may be configuration of CG resource for UE 402's UL SDT. In some aspects, the RRC release message may also be used for configuring the CG-SDT resources for the UE to use while the UE 402 is in an RRC inactive state. In some aspects, the CG resource configuration 406 may include one type 1 CG configuration. In some aspects, type 1 CG may be where an uplink grant is provided by RRC, and stored as configured uplink grant. The UE may use the resources provided by the type 1 CG without an additional DCI. In some aspects, type 2 CG may include an RRC configuration and an uplink grant that is provided by PDCCH such as DCI, and stored or cleared as configured uplink grant based on layer 1 (L1) signaling indicating configured uplink grant activation or deactivation. In the type 1 CG configuration, the network may RRC configure one or more of: a configured scheduling radio network temporary identifier (CS-RNT) for retransmission, a periodicity of the type 1 CG, a time domain offset representing offset of a resource in the time domain, a time domain allocation representing allocation of configured uplink grant in time domain which may include starting symbol and length, a number of HARQ processes for the CG, or the like. In some aspects, the CG resource configuration 406 may include multiple CG-SDT configurations per carrier in the RRC inactive state which may be supported by the network associated with the base station 404.

In some aspects, after receiving the CG resource configuration 406, the UE 402 may be in an RRC inactive state at 408. At some point in the RRC inactive state, the UE 402 may transmit a first UL message 410 to the base station 404. For example, the first UL message may be associated with SDT. In some aspects, the first UL message 410 may be transmitted via a CG transmission and may include an RRC resume request and uplink data. Upon receiving the first UL message 410, the base station 404 may transmit a network response 412 to the UE 402. In some aspects, the network response 412 may include an acknowledgment (ACK) or a retransmission. In some aspects, the network response 412 may not include an RRC message (e.g., because the UE 402 is still in the RRC inactive state).

In some aspects, after receiving the network response 412, the UE 402 may transmit additional uplink data 414 to the base station 404 in subsequent data transmissions. In some aspects, for CG-SDT, the subsequent data transmission may use the CG resource for new data transmission or may be based on a dynamic grant (DG) of resources for the uplink retransmission. In some aspects, upon receiving the uplink data 414, the base station 404 may transmit downlink data 416 in response to the uplink data 414. In some aspects, the UE 402 may transmit more uplink data 418 to the base station 404 upon receiving the downlink data 416 in response to the uplink data 414. At some point, the base station may transmit an RRC release 420 (e.g., which may also include a suspend configuration, such as a SuspendConfig 1E) to the UE 402. In some aspects, the RRC release 420 may terminate the SDT procedure from RRC point of view.

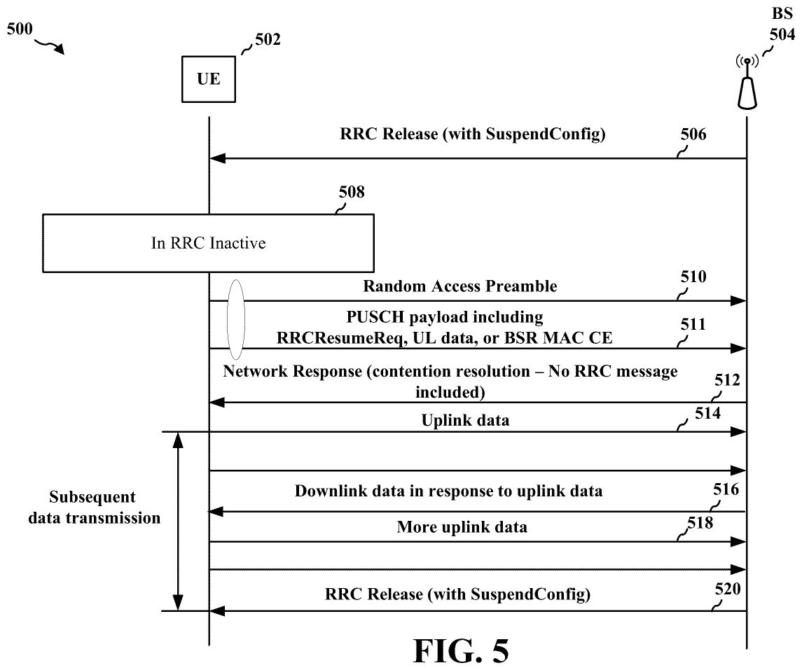

In addition to CG SDT, SDT may also be random access (RA) based. For example, FIG. 5 is a diagram 500 illustrating an example RA-SDT that may be MO and may be used in conjunction with a 2-step RACH procedure. As illustrated in FIG. 5, the base station 504 may transmit an RRC release message 506 to the UE 502. The RRC release message 506 may be associated with a suspend configuration, such as a SuspendConfig 1E. The suspend configuration may provide may provide information to the UE 502, such as an RNA update, paging cycle, or the like.

In some aspects, after receiving the RRC release message 506, the UE 502 may be in an RRC inactive state at 508. At some point in the RRC inactive state, the UE 502 may transmit a random access preamble 510 to the base station 504. The random access preamble 510 may be contention based random access (CBRA). In CBRA, the UE 502 may randomly select a random access preamble sequence, e.g., from a set of preamble sequences, to transmit the random access preamble 510. As the UE 502 randomly selects the preamble sequence, the base station 504 may receive another preamble from a different UE at the same time. Thus, CBRA provides for the base station 504 to resolve such contention among multiple UEs. Prior to transmitting the random access preamble 510, the UE 502 may obtain random access parameters, e.g., including preamble format parameters, time and frequency resources, parameters for determining root sequences and/or cyclic shifts for a random access preamble, etc., e.g., in SI. The preamble may be transmitted with an identifier, such as a RA-RNTI.

After transmitting the random access preamble 510 to the base station 504, the UE 502 may also transmit a PUSCH payload 511 to the base station 504. In some aspects, the PUSCH payload 511 may include an RRC resume request, UL data, or buffer status reporting (BSR) medium access control (MAC) control element (MAC-CE). Upon receiving the PUSCH payload 511, the base station 504 may transmit a network response 512 to the UE 502. In some aspects, the network response 512 may include a contention resolution. In some aspects, the network response 512 may not include an RRC message (e.g., because the UE 402 is still in the RRC inactive state).

In some aspects, after receiving the network response 512, the UE 502 may transmit additional uplink data 514 to the base station 504 in subsequent data transmissions. In some aspects, for RA-SDT, the UE 502 may reestablish an SDT PDCP and may resume SDT RBs that may be configured for small data. In some aspects, in the subsequent data transmissions (after successful contention resolution), the UE 502 may monitor for dynamic grant (DG) by cell RNTI C-RNTI in a separate common search space (CSS) (if configured) in RA-SDT.

In some aspects, upon receiving the uplink data 514, the base station 504 may transmit downlink data 516 in response to the uplink data 514. In some aspects, the UE 502 may transmit more uplink data 518 to the base station 504 upon receiving the downlink data 516 in response to the uplink data 514. At some point, the base station may transmit an RRC release 520 (e.g., which may also include a suspend configuration, such as a SuspendConfig 1E) to the UE 502. In some aspects, the RRC release 520 may terminate the SDT procedure from RRC point of view.

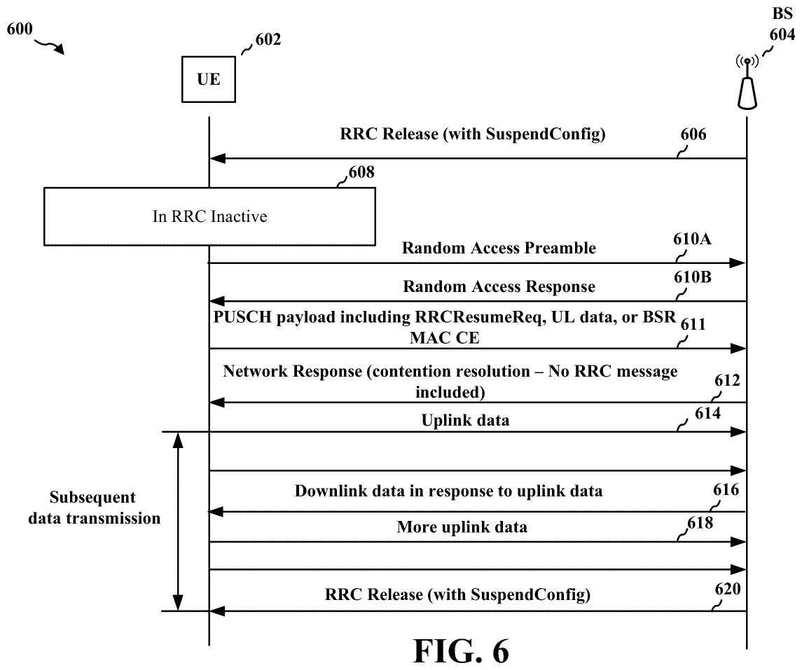

In another example, FIG. 6 is a diagram 600 illustrating an example RA-SDT that may be MO and may be used in conjunction with a 4-step RACH procedure. As illustrated in FIG. 6, the base station 604 may transmit an RRC release message 606 to the UE 602. The CG RRC release message 606 may be associated with a suspend configuration, such as a SuspendConfig 1E. The suspend configuration may provide may provide information to the UE 602, such as an RNA update, paging cycle, or the like.

In some aspects, after receiving the RRC release message 606, the UE 602 may be in an RRC inactive state at 608. At some point in the RRC inactive state, the UE 602 may transmit a random access preamble 610A to the base station 604. The random access preamble 610A may be CBRA. In CBRA, the UE 602 may randomly select a random access preamble sequence, e.g., from a set of preamble sequences, to transmit the random access preamble 610A. As the UE 602 randomly selects the preamble sequence, the base station 604 may receive another preamble from a different UE at the same time. Thus, CBRA provides for the base station 604 to resolve such contention among multiple UEs. Prior to transmitting the random access preamble 610A, the UE 602 may obtain random access parameters, e.g., including preamble format parameters, time and frequency resources, parameters for determining root sequences and/or cyclic shifts for a random access preamble, etc., e.g., in SI. The preamble may be transmitted with an identifier, such as a RA-RNTI.

After transmitting the random access preamble 610A to the base station 604, the UE 602 may receive a random access response 610B from the base station 604. Upon receiving the random access response 610B from the base station 604, also transmit a PUSCH payload 611 to the base station 604. In some aspects, the PUSCH payload 611 may include an RRC resume request, UL data, or BSR MAC-CE) Upon receiving the PUSCH payload 611, the base station 604 may transmit a network response 612 to the UE 602. In some aspects, the network response 612 may include a contention resolution. In some aspects, the network response 612 may not include an RRC message (e.g., because the UE 402 is still in the RRC inactive state).

In some aspects, after receiving the network response 612, the UE 602 may transmit additional uplink data 614 to the base station 604 in subsequent data transmissions. In some aspects, for RA-SDT, the UE 602 may reestablish an SDT PDCP and may resume SDT RBs that may be configured for small data. In some aspects, in the subsequent data transmissions (after successful contention resolution), the UE 602 may monitor for a DG by cell RNTI C-RNTI in a separate common search space (CSS) (if configured) in RA-SDT.

In some aspects, upon receiving the uplink data 614, the base station 604 may transmit downlink data 616 in response to the uplink data 614. In some aspects, the UE 602 may transmit more uplink data 618 to the base station 604 upon receiving the downlink data 616 in response to the uplink data 614. At some point, the base station may transmit an RRC release 620 (e.g., which may also include a suspend configuration, such as a SuspendConfig 1E) to the UE 602. In some aspects, the RRC release 620 may terminate the SDT procedure from RRC point of view.

In MO-SDT, non-SDT DL data may be supported (e.g., in DL data 416, 516, or 616). For example, in CG-SDT, the CG-SDT resource may be configured in a previous RRC release signaling. The DL data may be scheduled by dynamic grant. The UE may monitor UE-specific search space addressed to C-RNTI even when is no UL transmission.

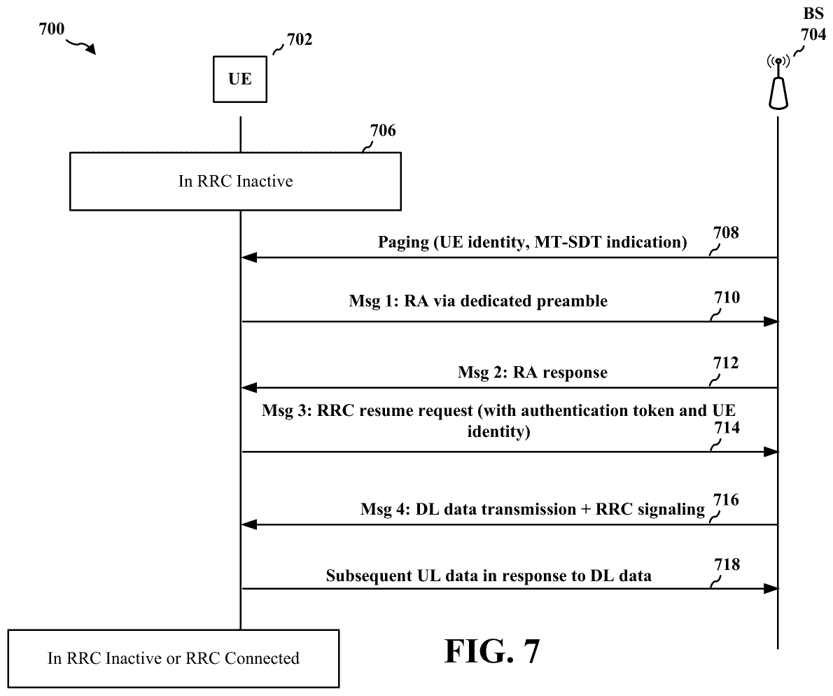

In addition to MO-SDT, MT-SDT may also be supported by a UE. For example, FIG. 7 is a diagram 700 illustrating an example MT-SDT that may be Msg 4 based. In some aspects, a Msg 2 (random access response) based SDT may include DL data for a UE with an identity that may not be verified. Msg 4 based MT-SDT may address such an issue. As illustrated in FIG. 7, a UE 702 may be in an RRC inactive state at 706. The UE 702 may receive paging 708 from the base station 704. In some aspects, the paging 708 may be associated with a UE identity associated with the UE 702. For example, the paging 708 may include an identifier (ID) that may be used for deriving an ID associated with the UE 702. In some aspects, the paging 708 may also include an MT-SDT indication associated with the UE 702. Upon receiving the paging 708, the UE 702 may transmit an RA preamble 710 via dedicated preamble to the base station 704. In some aspects, the UE 702 may be allowed to use MO-SDT preamble for RACH for DL data reception as long as an MT-SDT indication is paged in the paging 708 instead of using dedicated RACH resources.

In some aspects, upon receiving the RA preamble 710, the base station 704 may transmit an RA response 712 to the UE 702. In some aspects, upon receiving the RA response 712, the UE 702 may transmit an RRC resume request 714 in Msg 3 to the base station 704. In some aspects, the UE 702 may indicate in Msg3 whether UE intends to send data in UL, e.g., by BSR or UE assistance information (similar to MO-SDT). In some aspects, the RRC resume request 714 may include an authentication token with UE identity associated with the UE 702. Based on the authentication token with UE identity associated with the UE 702, the base station 704 may verify identity of the UE 702 and accordingly transmit Msg 4 716 which may be ciphered with the authentication token. In some aspects, the Msg 4 716 may include DL data. In some aspects, the Msg 4 716 may include RRC signaling. The UE 702 may transmit subsequent UL data 718 to the base station 704 upon receiving the DL data 716. In some aspects, the base station 704 may transmit an RRC resume message to the UE 702 if the UE 702 is allowed to send UL in RRC connected state but not RRC inactive state or transmit an RRC release to keep UE in inactive for UL response.

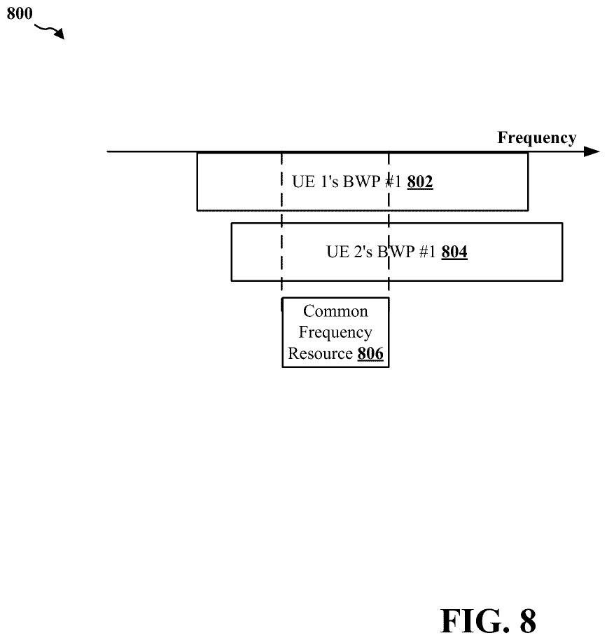

A common frequency resource (CFR) for group common PDCCH or PDSCH may be confined within the frequency resource of an initial or dedicated bandwidth part (BWP) of different UEs (belonging to same or different UE types or capabilities) and using the same numerology (SCS and cyclic prefix (CP)). For example, FIG. 8 is a diagram 800 illustrating an example CFR. As illustrated in FIG. 8, a BWP 802 of a first UE and a BWP 804 of a second UE may include a CFR 806. In some aspects, a CFR may include one or more configurations: a starting PRB and a number of PRBs, a starting PRB and a common reference, or RS, PDCCH, or PDSCH configurations within the CFR.

In some wireless communication systems, SDT, including MO-SDT and MT-SDT in an RRC inactive state may be supported. MBS in all RRC states, including the RRC inactive state, may also be supported. In some aspects, RAN nodes in cells may form an MBS SFN area. A cell within an MBS SFN area may be designated a reserved cell. Reserved cells may not provide multicast/broadcast content, but may time-synchronized to the cells and may have restricted power on MBS SFN resources in order to limit interference to the MBS SFN areas. Each RAN node in an MBS SFN area synchronously transmits the same MBS control information and data. For example, the cells (e.g., RAN nodes) may transmit transmissions at the same time (e.g., synchronously) and with the same frequency resources, and the transmissions may include the same control and/or data. A UE may receive the transmissions as though the transmissions were from a single cell, e.g., based on the synchronous transmission of the same information using the same frequency resources. Each area may support broadcast, multicast, and unicast services. A unicast service is provided for a specific user, e.g., a voice call. A multicast service is a service that may be received by a group of users, e.g., a subscription video service. A broadcast service is a service that may be received by all users, e.g., a news broadcast. In some aspects, a first MBS SFN area may support a first MBS broadcast service, such as by providing a particular news broadcast to UEs. The second MBS SFN area may support a second MBS broadcast service, such as by providing a different news broadcast to UEs. Each MBS SFN area may support one or more physical multicast channels (PMCH) or PDCCH scheduled PDSCH. Each PMCH or PDCCH scheduled PDSCH corresponds to an MCH or DL-SCH. Each MCH or DL-SCH can multiplex a plurality of multicast logical channels. Each MBS SFN area may have one multicast control channel (MCCH). As such, one MCH or DL-SCH may multiplex one or more MCCH and a plurality of multicast traffic channels (MTCHs) and the remaining MCHs or DL-SCH may multiplex a plurality of MTCHs.

A UE can camp on a cell to discover the availability of an MBS service access and a corresponding configuration. Initially, the UE may acquire system information, and based on the system information may acquire an MBS SFN area configuration message on an MCCH. The system information may include an MBS SFN area identifier of each MBS SFN area supported by the cell, information for acquiring the MCCH such as an MCCH repetition period, an MCCH offset, an MCCH modification period, a signaling MCS, subframe allocation information indicating which subframes of the radio frame as indicated by repetition period and offset can transmit MCCH; and/or an MCCH change notification configuration. The MBS SFN area configuration message may indicate a group identity, one or more session identifiers, allocated resources for each PMCH, an MCH scheduling period, or dynamic PDCCH based PDSCH scheduling, etc. The UE may receive control information that indicates, e.g., a starting point for each scheduling period of a PMCH, a channel identifier, and/or a field indicating an end of the MTCH.

In some aspects, to improve the reliability of multicast for RRC connected UEs, ACK/NACK based HARQ feedback and NACK-only based HARQ feedback may be supported. Aspects provided herein provide joint support for SDT including MO-SDT and MT-SDT and MBS (with or without retransmissions triggered by HARQ feedback of UE) for a UE in the RRC inactive state. For example, sensor networks for environmental monitoring, factory automation, smart home receiving periodic software and firmware update or mission-critical signaling may all be example UEs that may support SDT (including MO-SDT and MT-SDT) and MBS. With the aspects provided herein, a UE may benefit from power saving, latency or signaling overhead reduction, and reliability improvement for multicast in RRC inactive state enabled by, for example, P2P retransmission and priority indication. Some aspects, as provided herein, include support of multicast reception by UEs in an RRC inactive state. The UE may use shared processing for MBS broadcast and unicast reception. Based on aspects provided herein, a UE in RRC inactive state may receive multicast data configured by semi-persistent scheduling (SPS) or scheduled by DCI. If a UE does not have a valid timing advance (TA) and valid UL resources (PUCCH or PUSCH) in the RRC inactive state, the UE may not transmit a HARQ NACK to trigger retransmission of MBS that is not accurately received by the UE nor transmit a MAC-CE to activate or deactivate SPS configurations for the MBS. Aspects provided herein improve service continuity, reliability, and resource utilization efficiency of MBS by addressing such inability to trigger retransmission of MBS or deactivate SPS configurations for MBS, while still enabling the UE to remain in the RRC inactive state. As described herein, a UE may support both SDT and MBS session in the RRC inactive state. The joint support for SDT enables the UE to transmit HARQ feedback for MT-SDT or MBS the same set of PUCCH resource. For example, the UE may have PUCCH resources for SDT while remaining in RRC inactive, and the UE may use the PUCCH resources to transmit a HARQ NACK for the MBS while remaining in the RRC inactive state. The use of the SDT PUCCH resources can help to reduce system overhead for uplink communication and improve the reliability for downlink MBS reception by providing for the UE to inform the network when the UE has not received the MBS.

In some aspects, the joint support for MBS and MT-SDT enables the UE to transmit data or control information on the uplink using the configured CG-SDT resources, which enables a signaling overhead reduction and UE power saving because there is reduced PDCCH monitoring at the UE. As the CG-SDT resources are preconfigured, the UE can skip monitoring for PDCCH with a grant of resources before transmitting the data or control. The data or control can be for MBS, for example, and the UE can transmit the uplink data or control without monitoring for a separate grant of resources because the UE already has the CG-SDT resources configured. The network also saves signaling overhead by not sending the DCI allocating resources for the data or control.

In some aspects, the joint support for MBS and MT-SDT enables the network to perform link adaptation for MBS (for initial transmission or retransmission) based on CSI reports from the UE (or a group of UEs) via MO-SDT. The use of the MO-SDT resources to provide the CSI feedback for the MBS may result in improvements in reliability. As the network does not send a separate set of resources for transmission of the CSI, the use of the MO-SDT resources already configured for the UE provides resource utilization efficiency and can save overhead signaling.

In some aspects, the joint support for MBS and MT-SDT enables the network to multiplex MBS and MT-SDT in a downlink transmission to the UE, which may result in reduced PDCCH monitoring for UE power saving, system overhead reduction on DL, and/or latency reduction. The network can send the MT-SDT and MBS together without additional signaling to inform the UE of the MT-SDT, which can save on overhead signaling from the network and saves power at the UE because the UE may skip monitoring for such signaling.

In some aspects, the joint support for MBS and MT-SDT enables the UE to provide periodic, semi-static, or on-demand (e.g., based on a UE request in a MO-SDT) updates for software or firmware (e.g., in downlink MBS based transmission) of UEs in low power state. The combined use of the CG-SDT resources and the MBS resources may result in system overhead reduction and UE power savings, e.g., by using configured resources without added PDCCH signaling, and the UE skipping monitoring for the added PDCCH signaling.

In some aspects, the joint support for MBS and MT-SDT enables joint configurations for MBS and SDT by dedicated RRC signaling. As an example, a single RRC release message for MBS and SDT may be RRC configured, which may result in signaling overhead reduction in both the downlink and uplink directions because a single HARQ-ACK may be used for the joint configuration or joint message.

In some aspects, the joint support for MBS and MT-SDT enables the network to send the UE reconfiguration signaling for MBS in MT-SDT downlink resources for the UE. The UE may send UE assistance information (UAI) in CG-SDT resources for MO-SDT. The use of the SDT resources to reconfigure MBS allows added flexibility for network scheduling.

In some aspects, the joint support for MBS and MT-SDT enables the network to provide paging triggered MT-SDT to assist retransmission of MBS, e.g., for extended reality users. For example, SDT and a MBS session may be multiplexed for the UE in the RRC inactive state.

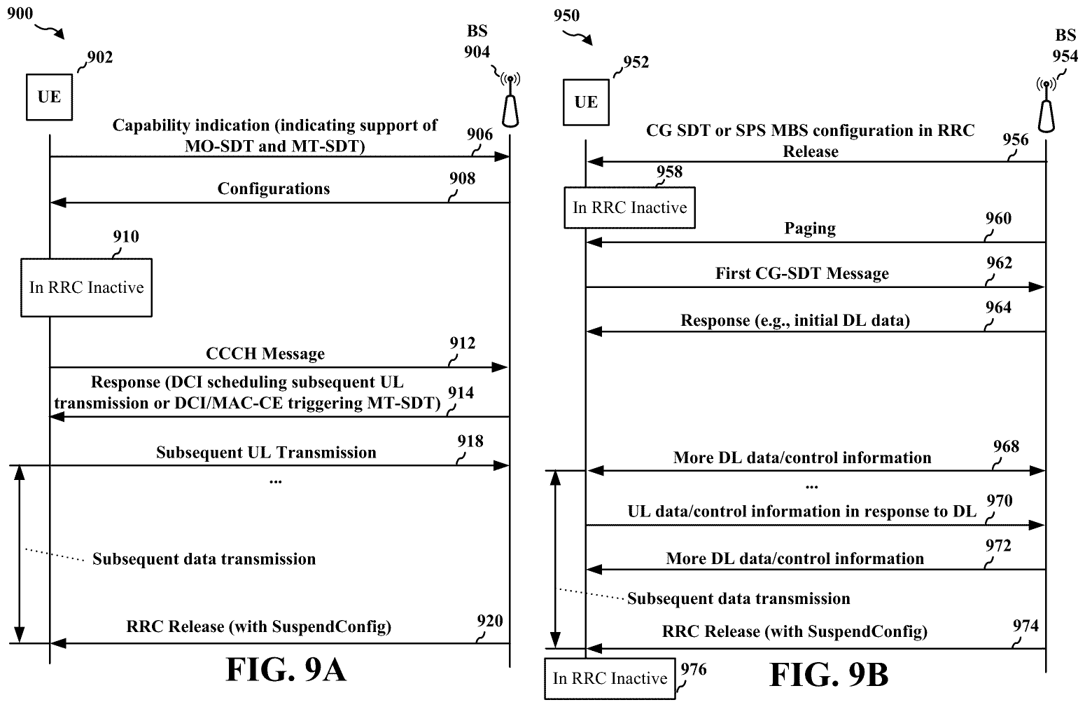

FIG. 9A is a diagram 900 illustrating joint support of MO-SDT and MT-SDT. In some aspects, MO-SDT and MT-SDT may be jointly supported by a UE 902 that may enter an RRC inactive state at 910. In some aspects, prior to the start of SDT, the UE 902 may signal to network (e.g., by transmitting to base station 904) a capability indication 906 representing the UE 902's capabilities for joint support of MO-SDT and MT-SDT. Upon receiving the capability indication 906 representing the UE 902's capabilities for joint support of MO-SDT and MT-SDT, the base station 904 may transmit a configuration 908, which may include configurations for MO-SDT and MT-SDT, to the UE 902. Although the aspects performed by 904 in FIG. 9A are described for a base station, the aspects may be performed by an aggregated base station, or alternatively, as a CU, a DU, an RU, a Near-Real Time (Near-RT) RAN Intelligent Controller (RIC), or a Non-Real Time (Non-RT) RIC in a disaggregated base station architecture. In some aspects, the configuration 908 may be multiplexed (or may include) an RRC release message with a suspend configuration (e.g., a SuspendConfig 1E). In some aspects, the configuration 908 may include one or more MT/MO SDT configurations such as: a radio resource allocation for DL/UL control and data channels, DL RS resource(s) for timing advance (TA) validation/power control/positioning/QCL/spatial relation, data volume thresholds for MT-SDT/MO-SDT selection or non-SDT selection, reference signal received power (RSRP) thresholds for SDT type selection, SDT/non-SDT selection, beam management, TA validation, or the like.

In some aspects, radio resources for MO-SDT and MT-SDT may be respectively configured in the initial DL BWP or a dedicated DL BWP and also in an initial UL BWP or a dedicated UL BWP of the UE 902. As the resources are for MO-SDT and MT-SDT, the UE will have resources configured for both downlink and uplink SDT, e.g., in a pair of BWPs that includes a downlink BWP and an uplink BWP. For example, for different UE types or capabilities (such as regular or reduced capability) jointly supporting MO-SDT and MT-SDT, the initial or dedicated UL BWP configurations may be the same or different. For example, UEs of different types may have a common initial UL BWP or a common dedicated UL BWP. Alternatively, a first type of UE, such as a reduced capability UEs, may have a different initial UL BWP than a second type of UE, such as non-reduced capability UEs. Similarly, the first type of UE may have a different dedicated UL BWP than the second type of UE. The initial or dedicated DL BWP configurations may be the same or different for different UE types. In addition, for different UE types or capabilities (such as regular or reduced capability) jointly supporting MO-SDT and MT-SDT and sharing a same initial or dedicated DL/UL BWP, MO-SDT and MT-SDT configurations may be the same or different. For example, the first type of UE may share a same initial/dedicated DL BWP and a same initial/dedicated UL BWP with the second type of UE, yet the two types of UEs may have different configurations for MO-SDT and/or MT-SDT.

To initiate the SDT procedure, the UE 902 may transmit a CCCH message 912 in an initial MO-SDT transmission to the base station 904 while remaining the RRC inactive state and without transitioning to an RRC connected state. Upon receiving the CCCH message 912, the base station 904 may respond and transmit a response 914 to the UE 902. The response 914 may be an implicit or explicit ACK for the CCCH message 912. In some aspects, UE specific SDT on UL or DL cannot proceed in the RRC inactive state until the UE 902 receives the response 914 (e.g., an ACK (implicit or explicit)) for its initial MO-SDT transmission with the CCCH message 912. In some aspects, the response 914 may be DCI scheduling subsequent UL transmission 918 of the UE 902. In some aspects, the response 914 may be DCI or MAC-CE triggering the MT-SDT of the UE 902. For example, the network may send MT-SDT to the UE while the UE is in the RRC inactive state and without the UE transitioning to the RRC connected state. The MT-SDT may be based on the MT-SDT configuration for the UE. In some aspects, at some point, the UE 902 may receive an RRC release 920 with a suspend configuration (e.g., a SuspendConfig 1E) which may terminate the SDT. In some aspects, the suspend configuration may provide may provide information to the UE 902, such as an RNA update, paging cycle, or the like.

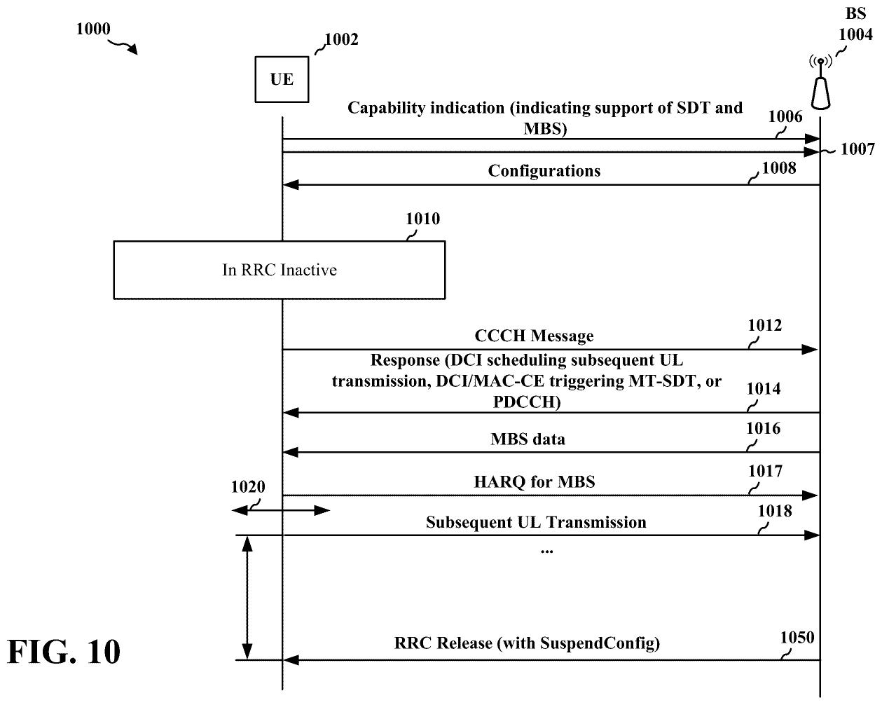

FIG. 9B is a diagram 950 illustrating communication between a network and a UE that has joint support of SDT and MBS while the UE is in RRC inactive state, in accordance with various aspects of the present disclosure. As illustrated in FIG. 9B, the UE 952 may receive, from the network entity 954, a CG-SDT configuration and an MBS configuration 956 (e.g., a semi-persistent scheduling (SPS) MBS configuration) from the network entity 954. In some aspects, the configuration 956 may configure a joint SDT and MBS session. In some aspects, the configuration 956 may be a single RRC message, e.g., with one or more aspects configured together for the SDT and MBS. In other aspects, the UE may receive a first configuration for the CG-SDT (e.g., as described in connection with FIG. 9A) and may receive a second configuration for the MBS (e.g., as described in connection with FIG. 10).

As shown at 958, the UE 952 may enter an RRC inactive state, e.g., based on a release message. While in the RRC inactive state, the UE 952 may receive paging 960 from the network entity 954. In some aspects, the paging 960 may be for SDT or for MBS, such as a paging based indication for MT-SDT, paging for initial transmission of MBS, or paging for retransmission of MBS.

Upon receiving the paging 960, the UE 952 may transmit a first SDT message 962 to the network entity 954. In some aspects, the first SDT message 962 may include RRC resume request (e.g., represented by a RRCResumeRequest information element). In some aspects, the first SDT message 962 may include an identifier (ID) associated with the UE 952. In some aspects, the first SDT message 962 may include a MAC-CE for MBS.

Upon receiving the first SDT message 962, the network entity 954 may respond with a response 964, which may be initial DL data for the UE 952 (e.g., initial DL data associated with the paging 960). In some aspects, the response 964 may include DL data or control information scheduled by C-RNTI or group RNTI of MBS. The response may include any of the aspects described herein for communication based on joint support of SDT and MBS.

Subsequent data transmission may occur after the network entity 954 sends the response 964 to the UE 952. For example, network entity 954 may transmit more DL data or control information 968 to the UE 952. In some aspects, the DL data or control information 968 may include DL data or control information for MT-SDT or MBS scheduled by C-RNTI, P-RNTI, or group RNTI of MBS. The downlink transmission may include any of the aspects described herein for communication based on joint support of SDT and MBS. The UE 952 may also transmit UL data or control information 970 in response to DL, which may be HARQ feedback for MT-SDT or MBS, UE assistance information (UAI), CSI report, MO-SDT, UCI (e.g., SR), MAC CE (e.g., buffer status report (BSR), power headroom report (PHR), or the like. The uplink transmission may include any of the aspects described herein for communication based on joint support of SDT and MBS. The network entity may transmit more DL data or control information 972 to the UE 952, which may also include DL data or control information for MT-SDT or MBS scheduled by C-RNTI, P-RNTI, or group RNTI of MBS. In some aspects, an RRC release message 974 with a suspend configuration (e.g., a SuspendConfig 1E) which may terminate the SDT or MBS, may be transmitted from the network entity 954 to the UE 952. For example, a single RRC release message 974 may terminate the SDT and the MBS. In some aspects, in addition to data or control information associated with SDT and MBS, paging early indication (PEI), wake up signal (WUS), DL RS including tracking reference signal (TRS), SSB, or positioning reference signal (PRS), UL RS including PRACH or SRS, may also be transmitted on DL/UL during joint SDT and MBS session (e.g., as part of the subsequent transmission). As illustrated at 976, the UE may continue in the RRC inactive state, and the communication between 958 and 976 may occur without the UE transitioning out of the RRC inactive state to an RRC connected state. The communication in FIG. 9B may include additional aspects described for SDT, such as in connection with FIG. 9A, and may include additional aspects described for MBS, such as in connection with FIG. 10.

FIG. 10 is a diagram 1000 illustrating joint support of SDT and MBS. In some aspects, SDT (e.g., MO-SDT or MT-SDT) and MBS (e.g., P2M MBS) may be jointly supported by a UE 1002 that may enter an RRC inactive state at 1010. In some aspects, prior to the start of SDT and MBS, the UE 1002 may signal to network (e.g., by transmitting to base station 1004) a capability indication 1006 representing the UE 1002's capabilities for joint support of SDT and MBS. Although the aspects performed by 1004 in FIG. 10 are described for a base station, the aspects may be performed by an aggregated base station, or alternatively, as a CU, a DU, an RU, a Near-RT RIC, or a Non-RT RIC in a disaggregated base station architecture. Upon receiving the capability indication 1006 representing the UE 1002's capabilities for joint support of SDT and MBS, the base station 1004 may transmit configuration 1008 which may include configurations for SDT and MBS to the UE 1002. In some aspects, the configuration 1008 may be multiplexed (or may include) an RRC release message with a suspend configuration (e.g., a SuspendConfig 1E). In some aspects, the configuration 1008 may be transmitted via RRC messages. In some aspects, the configuration 1008 may include a P2M MBS configuration that may be provided via SI or MAC-CE. In some aspects, the configuration 1008 may include one or more MT/MO SDT configurations such as: radio resource allocation for DL/UL control and data channels, DL RS resource(s) for timing advance (TA) validation/power control/positioning/QCL/spatial relation, data volume thresholds for MT-SDT/MO-SDT selection or non-SDT selection, reference signal received power (RSRP) thresholds for SDT type selection, SDT/non-SDT selection, beam management, TA validation, or the like. In some aspects, for the UE 1002 in the RRC inactive state, data volume thresholds for MBS or SDT may be the same or different.

In some aspects, radio resources for SDT and MBS may be respectively configured in the initial or dedicated DL BWP and initial or dedicated UL BWP of the UE 1002. For example, for different UE types or capabilities (such as regular or reduced capability) jointly supporting SDT and P2M MBS, radio resource configurations for SDT and P2M MBS may be the same or different. In some aspects, for different UE types or capabilities (such as regular or reduced capability) sharing a same initial or dedicated DL/UL BWP, the configurations for physical control/data channels or planes and RS on DL or UL may be the same or different. In some aspects, for the UE 1002 which jointly supports SDT and P2M MBS in the RRC inactive state, the configurations for physical control/data channels or planes and RS on DL/UL may be the same or different. For example, time domain resource allocation (TDRA), frequency domain resource allocation (FDRA), control resource set (CORESET), CSS, UE specific search space (USS), PUCCH, QCL, or spatial relation may be same or different.

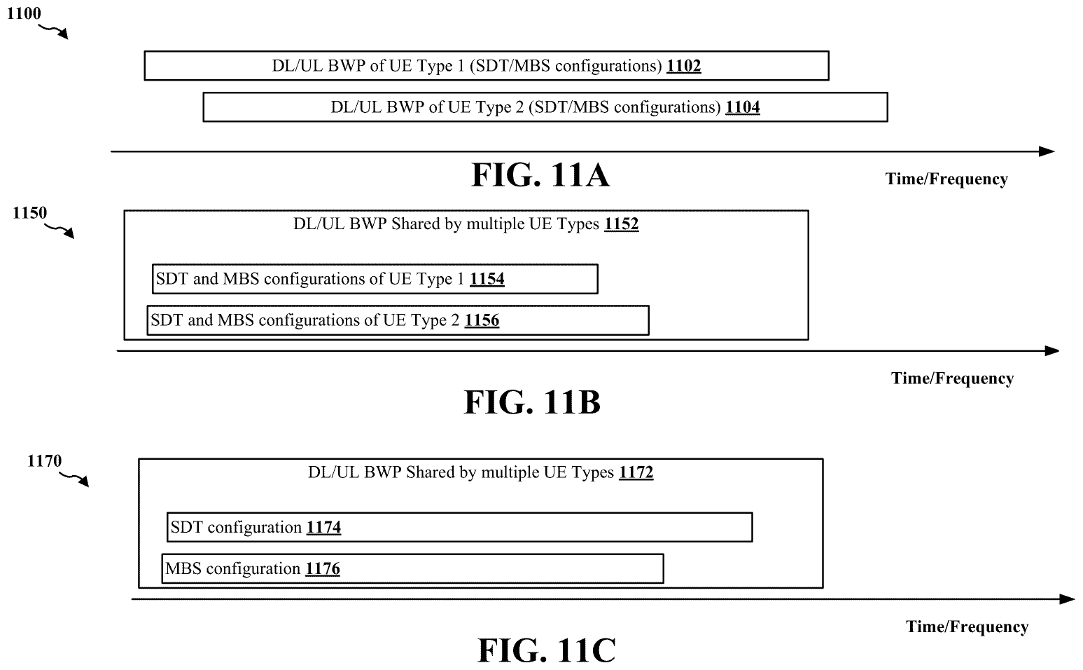

Referring to FIGS. 11A-C, FIGS. 11A, B, and C are diagrams 1100, 1150, and 1170 illustrating example resource configurations of SDT and MBS. As illustrated in FIG. 11A, DL/UL BWP of UE Type 1 (or a first capability) associated with both SDT and MBS configurations 1102 may be different from DL/UL BWP of UE Type 2 (or a second capability) associated with both SDT and MBS configurations 1104. As illustrated in FIG. 11B, DL/UL BWP 1152 may be shared by multiple UE types/capabilities. Inside the DL/UL BWP 1152, a BWP associated with SDT and MBS configurations for UE Type 1 (or a first capability) 1154 may be different from a BWP associated with SDT and MBS configurations for UE Type 2 (or a second capability) 1156. As illustrated in FIG. 11C, DL/UL BWP 1172 may be shared by multiple UE types/capabilities. Inside the DL/UL BWP 1172, BWP associated with SDT 1174 may be different from BWP associated with MBS configuration 1176.

Referring back to FIG. 10, for the UE 1002 that jointly supports SDT and MBS in the RRC inactive state, SDT procedure may be initiated by the UE 1002's initial MO-SDT transmission including a CCCH message 1012. In other words, to initiate the SDT procedure, the UE 1002 may transmit a CCCH message 1012 in an initial MO-SDT transmission to the base station 1004. Upon receiving the CCCH message 1012, the base station 1004 may respond and transmit a response 1014 to the UE 1002. The response 1014 may be an implicit or explicit ACK for the CCCH message 1012. In some aspects, UE specific SDT on UL or DL cannot proceed in the RRC inactive state until the UE 1002 receives the response 1014 (e.g., an ACK (implicit or explicit)) for its initial MO-SDT transmission with the CCCH message 1012. In some aspects, the response 1014 may be DCI scheduling subsequent UL transmission 1018 of the UE 1002. In some aspects, the response 1014 may be DCI or MAC-CE triggering the MT-SDT of the UE 1002. In some aspects, the response 1014 may be a PDCCH scheduling P2M MBS initial transmission or retransmission 1020 or the P2P retransmission of multicast may not be used as an implicit ACK for the UE's initial MO-SDT transmission with the CCCH message 1012.

In some aspects, the UE 1002's reception of MBS data 1016 may start before or after the UE 1002 receives the response 1014. In some aspects, the UE 1002's HARQ feedback 1017 for the MBS data 1016 may not be transmitted if: 1) the UE 1002 has not received the response 1014; 2) the UE 1002 does not have a valid TA; or 3) the UE's TA timer for SDT has expired.

In some aspects, at some point, the UE 1002 may receive an RRC release 1050 with a suspend configuration (e.g., a SuspendConfig 1E) which may terminate the SDT. In some aspects, the suspend configuration may provide may provide information to the UE 1002, such as an RNA update, paging cycle, or the like.

In some aspects, for the UE 1002 that supports both SDT and MBS in the RRC inactive state, the UE 1002 may support P2P retransmission 1020 for multicast within its initial DL BWP configured by MIB or SIB (e.g. SIB1). In some aspects, in the capability indication 1006 representing joint support of SDT and MBS (e.g., P2M initial transmission or retransmission scheduled by group common DCI (GC-DCI) on CFR defined within the initial or dedicated DL BWP) or a separate capability indication 1007, the UE 1002 may indicate support of P2P retransmission of multicast scheduled by a unicast DCI transmitted on the CFR.

In some aspects, the unicast DCI used by SDT (MO or MT) and the unicast DCI used by P2P retransmission of multicast may be configured with the same or different CORESET/USS sets. In some aspects, different RNTIs may be used to scramble the CRC of the unicast DCI associated with SDT and MBS. In some aspects, by default, the GC-DCI associated with SDT and the GC-DCI scheduling P2M initial transmission or retransmission of MBS may be configured with the same or different CORESET or CSS sets. In some aspects, the size of GC-DCI for SDT and MBS may be aligned. In some aspects, different RNTIs may be used to scramble the CRC of the GC-DCI associated with SDT and MBS. In some aspects, the UCI carrying HARQ feedback in SDT and the UCI carrying HARQ feedback for P2P retransmission of multicast may be configured with shared or separate PUCCH resources, or multiplexed with PUSCH transmission of MO-SDT (e.g., including msg3, msg A in a 2-step RACH procedure, CG-PUSCH, or subsequent UL data). In some aspects, the HARQ feedback in SDT and the HARQ feedback in P2P retransmission of multicast may be configured with the same or different priorities by RRC, DCI or MAC-CE. In some aspects, DL data associated with multicast and MT-SDT may be assigned with different HARQ process IDs.

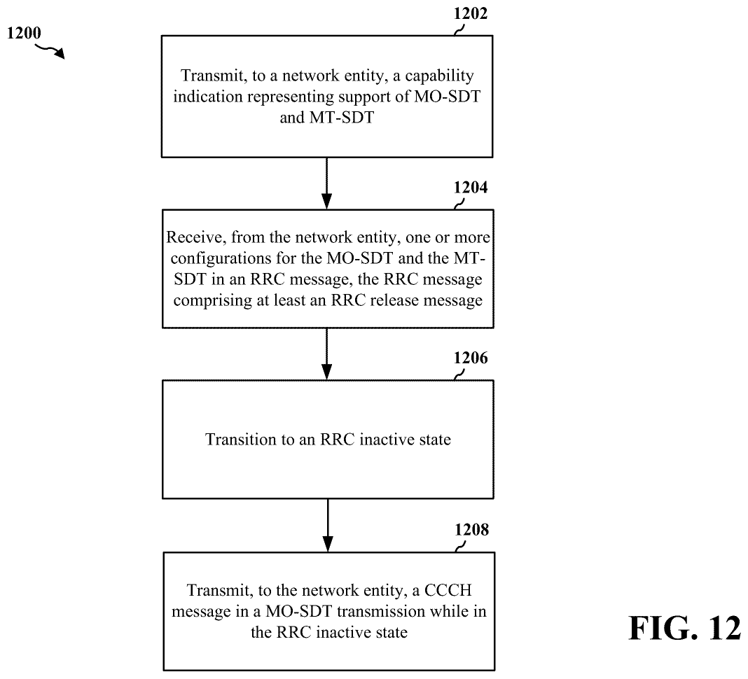

FIG. 12 is a flowchart 1200 of a method of wireless communication. The method may be performed by a UE (e.g., the UE 104, the UE 902; the apparatus 1802).

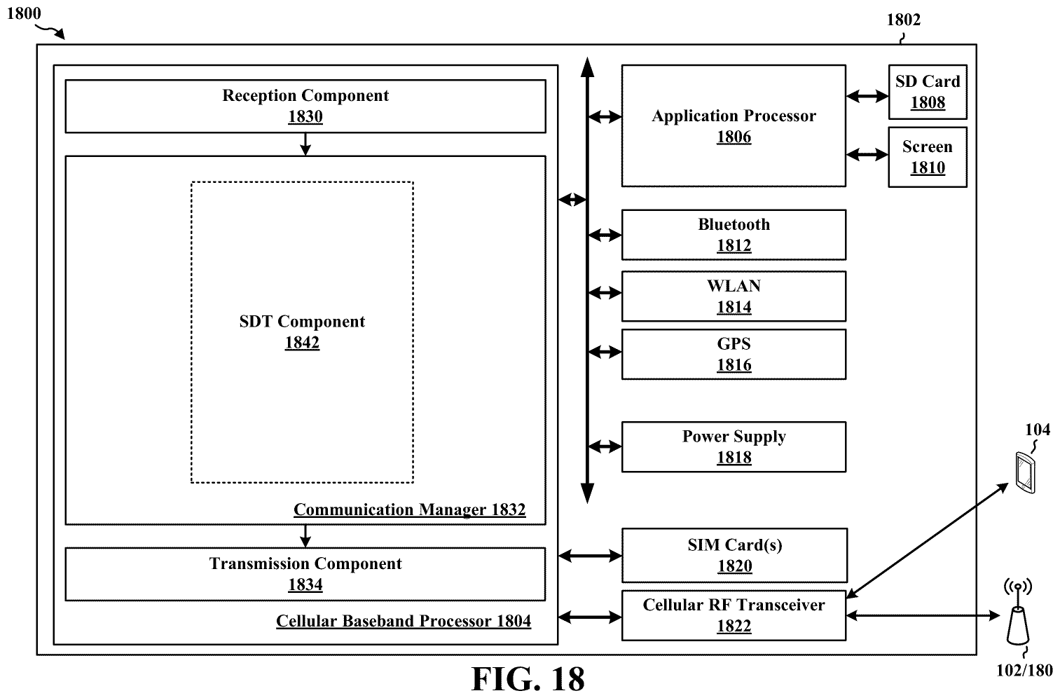

At 1202, the UE may transmit, to a network entity, a capability indication representing support of MO-SDT and MT-SDT. For example, the UE 902 may transmit, to a base station 904, a capability indication 906 representing support of MO-SDT and MT-SDT. In some aspects, 1202 may be performed by SDT component 1842 in FIG. 18.

At 1204, the UE may receive, from the network entity, one or more configurations for the MO-SDT and the MT-SDT in an RRC message, the RRC message including at least an RRC release message. For example, the UE 902 may receive, from the base station 904, one or more configurations 908 for the MO-SDT and the MT-SDT in an RRC message, the RRC message including at least an RRC release message. In some aspects, 1204 may be performed by SDT component 1842 in FIG. 18.

At 1206, the UE may transition to an RRC inactive state. For example, the UE 902 may transition to an RRC inactive state at 910. In some aspects, 1206 may be performed by SDT component 1842 in FIG. 18.

At 1208, the UE may transmit, to the network entity, a CCCH message in a MO-SDT transmission while in the RRC inactive state. For example, the UE 902 may transmit, to the base station 904, a CCCH message 912 in a MO-SDT transmission while remaining in the RRC inactive state. In some aspects, 1208 may be performed by SDT component 1842 in FIG. 18.

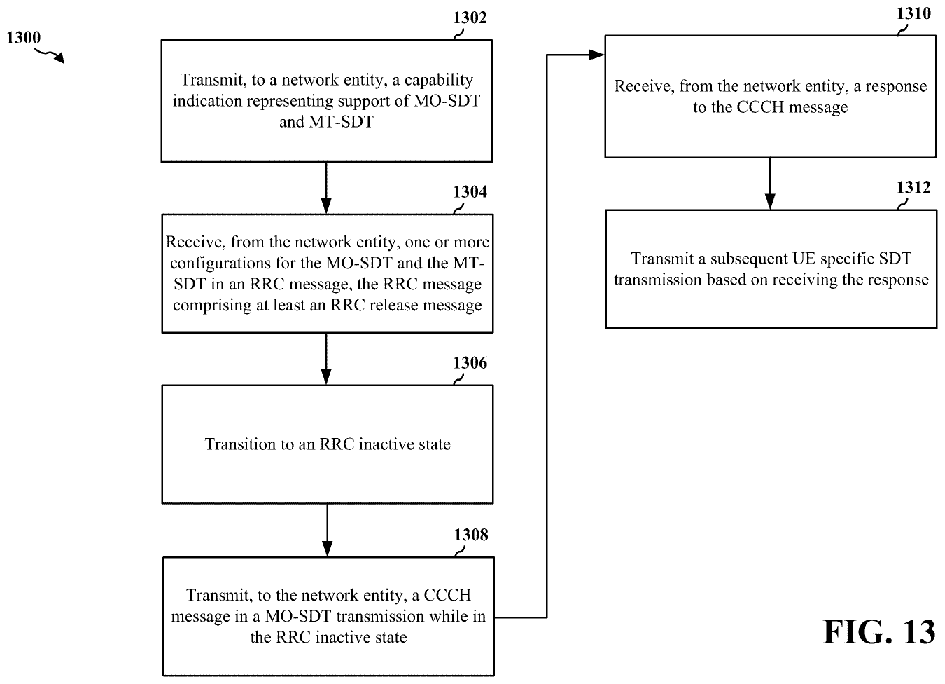

FIG. 13 is a flowchart 1300 of a method of wireless communication. The method may be performed by a UE (e.g., the UE 104, the UE 902; the apparatus 1802).

At 1302, the UE may transmit, to a network entity, a capability indication representing support of MO-SDT and MT-SDT. For example, the UE 902 may transmit, to a base station 904, a capability indication 906 representing support of MO-SDT and MT-SDT. In some aspects, 1302 may be performed by SDT component 1842 in FIG. 18.

At 1304, the UE may receive, from the network entity, one or more configurations for the MO-SDT and the MT-SDT in an RRC message, the RRC message including at least an RRC release message. For example, the UE 902 may receive, from the base station 904, one or more configurations 908 for the MO-SDT and the MT-SDT in an RRC message, the RRC message including at least an RRC release message. In some aspects, 1304 may be performed by SDT component 1842 in FIG. 18. In some aspects, the one or more configurations for the MO-SDT and the MT-SDT may include one or multiple DL RS resources for at least one of one or more RSRP measurements, a TA validation, a link quality evaluation, beam management, power control, positioning, one or more tracking loops, a quasi-colocation, or a spatial relation. In some aspects, the one or more configurations for the MO-SDT and the MT-SDT may include one or more data volume thresholds for an initiation of the MO-SDT and the MT-SDT. In some aspects, the one or more configurations for the MO-SDT and the MT-SDT may include a RSRP threshold associated with selecting the MO-SDT, the MT-SDT, or non-SDT, a beam management, a link quality evaluation, or a TA validation, and a value of the RSRP threshold depends on a type of procedures and one or more UE capabilities associated with the UE. In some aspects, the one or more configurations for the MO-SDT and the MT-SDT include downlink resources in an initial or dedicated DL BWP for the MT-SDT and the MO-SDT, and wherein the one or more configurations for the MO-SDT and the MT-SDT further include uplink resources in an initial or dedicated UL BWP for the MO-SDT and the MT-SDT. In some aspects, the initial or dedicated DL BWP and the initial or dedicated UL BWP are configured based on a UE type or one or more UE capabilities associated with the UE. In some aspects, the initial or dedicated DL BWP and the initial or dedicated UL BWP are independent of a UE type or a UE capability.

At 1306, the UE may transition to an RRC inactive state. For example, the UE 902 may transition to an RRC inactive state at 910. In some aspects, 1306 may be performed by SDT component 1842 in FIG. 18.

At 1308, the UE may transmit, to the network entity, a CCCH message in a MO-SDT transmission while in the RRC inactive state. For example, the UE 902 may transmit, to the base station 904, a CCCH message 912 in a MO-SDT transmission while in the RRC inactive state. In some aspects, 1308 may be performed by SDT component 1842 in FIG. 18.

At 1310, the UE may receive, from the network entity, a response to the CCCH message. For example, the UE 902 may receive, from the base station 904, a response 914 to the CCCH message 912. In some aspects, 1310 may be performed by SDT component 1842 in FIG. 18. In some aspects, the response is multiplexed with a DCI, an RRC message, or a MAC-CE triggering the MT-SDT for the UE. In some aspects, the response may include DCI scheduling a subsequent UL transmission or a CCCH message retransmission of the UE. In some aspects, the RRC release message is associated with a suspend configuration IE. In some aspects, the one or more configurations for the MO-SDT and the MT-SDT may include radio resource allocation for DL or UL messages belonging to control or data planes.

At 1312, the UE may transmit a subsequent UE specific SDT transmission based on receiving the response. For example, the UE 902 may transmit a subsequent UE specific SDT transmission (e.g., the subsequent UL transmission 918) based on receiving the response 914. In some aspects, 1312 may be performed by SDT component 1842 in FIG. 18.

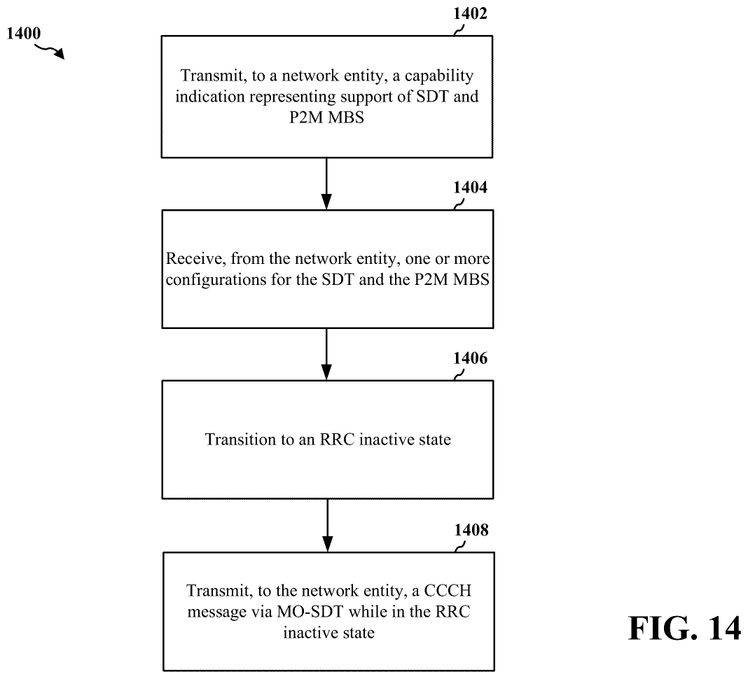

FIG. 14 is a flowchart 1400 of a method of wireless communication. The method may be performed by a UE (e.g., the UE 104, the UE 1002; the apparatus 1802).

At 1402, the UE may transmit, to a network entity, a capability indication representing support of SDT and P2M MBS. For example, the UE 1002 may transmit, to a base station 1004, a capability indication 1006 representing support of SDT and P2M MBS. In some aspects, 1402 may be performed by SDT component 1842 in FIG. 18.

At 1404, the UE may receive, from the network entity, one or more configurations for the SDT and the P2M MBS in an RRC message, the RRC message including at least an RRC release message. For example, the UE 1002 may receive, from the base station 1004, one or more configurations 1008 for the SDT and the P2M MBS in an RRC message, the RRC message including at least an RRC release message. In some aspects, 1404 may be performed by SDT component 1842 in FIG. 18.

At 1406, the UE may transition to an RRC inactive state. For example, the UE 1002 may transition to an RRC inactive state at 1010. In some aspects, 1406 may be performed by SDT component 1842 in FIG. 18.

At 1408, the UE may transmit, to the network entity, a CCCH message via MO-SDT while in the RRC inactive state. For example, the UE 1002 may transmit, to the base station 1004, a CCCH message 1012 in a MO-SDT transmission while in the RRC inactive state. In some aspects, 1408 may be performed by SDT component 1842 in FIG. 18.

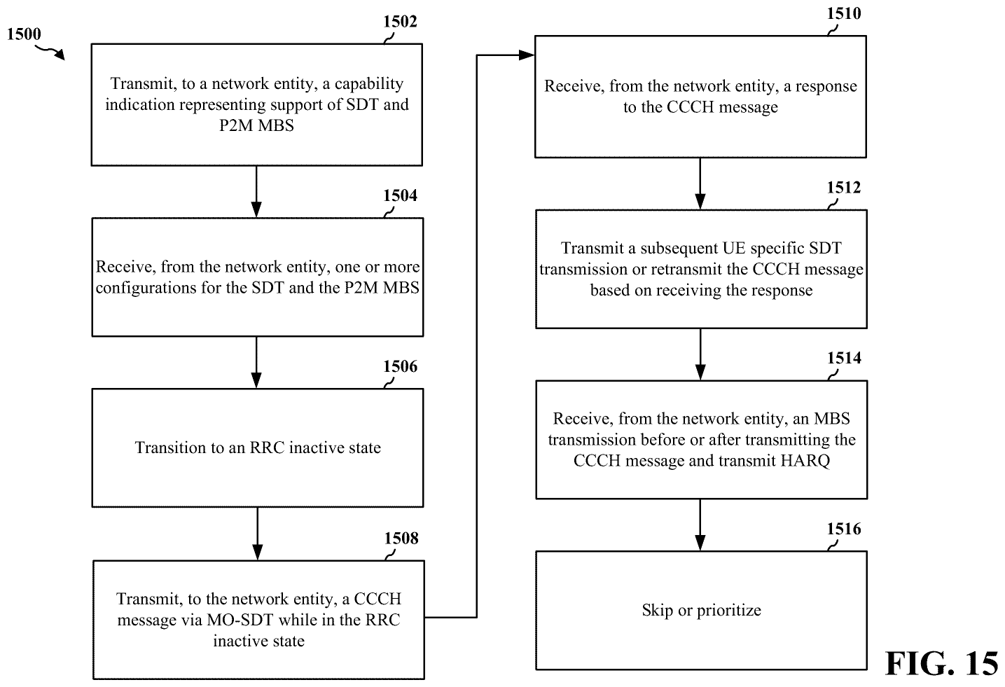

FIG. 15 is a flowchart 1500 of a method of wireless communication. The method may be performed by a UE (e.g., the UE 104, the UE 1002; the apparatus 1802).

At 1502, the UE may transmit, to a network entity, a capability indication representing support of SDT and P2M MBS. For example, the UE 1002 may transmit, to a base station 1004, a capability indication 1006 representing support of SDT and P2M MBS. In some aspects, 1502 may be performed by SDT component 1842 in FIG. 18.

At 1504, the UE may receive, from the network entity, one or more configurations for the SDT and the P2M MBS in an RRC message, the RRC message including at least an RRC release message. For example, the UE 1002 may receive, from the base station 1004, one or more configurations 1008 for the SDT and the P2M MBS in an RRC message, the RRC message including at least an RRC release message. In some aspects, 1504 may be performed by SDT component 1842 in FIG. 18. In some aspects, the one or more configurations for the SDT and the P2M MBS are received/transmitted via an RRC message. In some aspects, the RRC message may include at least an RRC release message associated with a suspend configuration, and the one or more configurations for the SDT and the P2M MBS are received/transmitted via SI or MAC-CE. In some aspects, the one or more configurations for the SDT and the P2M include joint resources in an initial or dedicated DL BWP and an initial or dedicated UL BWP for the SDT or the P2M MBS or separate resources for the SDT or the P2M MBS in the initial or dedicated DL BWP and the initial or dedicated UL BWP. In some aspects, the joint resources or the initial or dedicated DL BWP or the initial or dedicated UL BWP are partitioned based on a UE type or one or more UE capabilities associated with the UE.

At 1506, the UE may transition to an RRC inactive state. For example, the UE 1002 may transition to an RRC inactive state at 1010. In some aspects, 1506 may be performed by SDT component 1842 in FIG. 18.

At 1508, the UE may transmit, to the network entity, a CCCH message via MO-SDT while in the RRC inactive state. For example, the UE 1002 may transmit, to the base station 1004, a CCCH message 1012 in a MO-SDT transmission while in the RRC inactive state. In some aspects, 1508 may be performed by SDT component 1842 in FIG. 18.

At 1510, the UE may receive, from the network entity, a response to the CCCH message. For example, the UE 1002 may receive, from the base station 1004, a response 1014 to the CCCH message 1012. In some aspects, 1510 may be performed by SDT component 1842 in FIG. 18. In some aspects, the response is multiplexed with a DCI, an RRC message, or a MAC-CE triggering the MT-SDT for the UE. In some aspects, the response may include PDCCH scheduling a P2M MBS transmission, a P2M retransmission, or a P2P retransmission. In some aspects, the response may include DCI scheduling a subsequent UL transmission or a CCCH message retransmission of the UE. In some aspects, the RRC release message is associated with a suspend configuration IE. I

At 1512, the UE may transmit a subsequent UE specific SDT transmission based on receiving the response. For example, the UE 1002 may transmit a subsequent UE specific SDT transmission (e.g., the subsequent UL transmission 1018) based on receiving the response 1014. In some aspects, 1512 may be performed by SDT component 1842 in FIG. 18.

At 1514, the UE may receive, from the network entity, an MBS transmission before or after transmitting the CCCH message. For example, the UE 1002 may receive, from the base station 1004, an MBS transmission (e.g., MBS data 1016) before or after transmitting the CCCH message 1012. In some aspects, 1514 may be performed by SDT component 1842 in FIG. 18.

In some aspects, the UE may transmit, to the network entity, a HARQ feedback for the MBS transmission based on a valid TA, an unexpired TA timer for the SDT, and the response to the CCCH message. For example, the UE 1002 may transmit, to the base station 1004, a HARQ feedback (e.g., 1017) for the MBS transmission based on a valid TA an unexpired TA timer for the SDT, and the response to the CCCH message.

In some aspects, an initial or dedicated DL BWP is configured via a MIB, an RRC message or a SIB, and the capability indication further represents support of P2P retransmission for multicast associated with the P2M MBS. In some aspects, a UL BWP is configured via an RRC message or a SIB. In some aspects, the capability indication further represents support HARQ feedback to a P2P or P2M retransmission for multicast associated with the P2M MBS, and the HARQ feedback is transmitted on common UL resources for a group of UEs including the UE or dedicated UL resources for the UE. In some aspects, a HARQ feedback to MBS transmission or retransmission is multiplexed with a HARQ feedback to MT-SDT transmission or retransmission and other control information on the common UL resources or the dedicated UL resources. In some aspects, a HARQ feedback to the P2M MBS or a MT-SDT is multiplexed with the MO-SDT transmission or retransmission on a same set common UL resources for a group of UEs including the UE or dedicated UL resources for the UE.

In some aspects, at 1516, the UE may skip or prioritize. For example, the UE may skip a transmission of UL control channel, UL data channel or UL RS associated with HARQ feedback to MBS, a HARQ feedback to MT-SDT, MO-SDT transmission or retransmission, positioning, channel state feedback based on one or more configured rules, a dynamic or semi-persistent priority indication, or a UE capability associated with the UE. In some aspects, the UE may skip a reception of DL control channel, DL data channel or DL RS associated with the P2M MBS transmission or retransmission, the MT-SDT transmission or retransmission, a HARQ feedback to the MO-SDT transmission, measurements (or other procedures), or positioning based on the one or more configured rules, the dynamic or semi-persistent priority indication, a UE power saving specification associated with the UE, the UE capability associated with the UE, or the like. In some aspects, prioritize a reception of a DL control channel, DL data channel, or DL RS or a transmission of UL control channel, UL data channel, or UL RS associated with the P2M MBS, a MT-SDT, the MO-SDT, positioning, or measurements (or other procedures) based on the UE not supporting transmit and receive simultaneously and an overlapping or insufficient switching gap between DL and UL, and where the prioritization may be further based on one or more configured rules, a dynamic or semi-persistent priority indication, a UE power saving specification associated with the UE, a UE capability associated with the UE, or the like. For example, if the UE supports half-duplex FDD without supporting full-duplex, the UE cannot transmit and receive simultaneously. Therefore, the UE may prioritize the DL reception and skip the UL transmission, or vice versa. In some aspects, if there is an overlapping among the UL resources associated with HARQ feedback to MBS, HARQ feedback to MT-SDT and MO-SDT transmission/retransmission, the UE can drop some of them based on priority or UE capability.

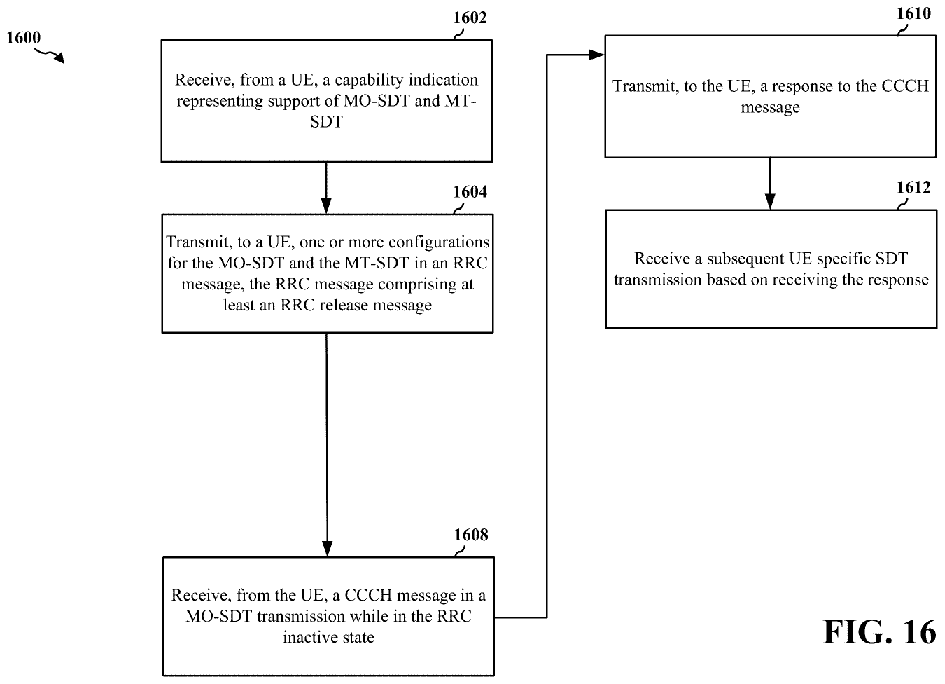

FIG. 16 is a flowchart 1600 of a method of wireless communication. The method may be performed by a network device (e.g., the base station 102/180, the base station 904; the apparatus 1902). In some aspects, the method may be performed by a base station (e.g., an aggregated base station), or alternatively, by a CU, a DU, an RU, a Near-Real Time (Near-RT) RAN Intelligent Controller (RIC), or a Non-Real Time (Non-RT) RIC in a disaggregated base station architecture.

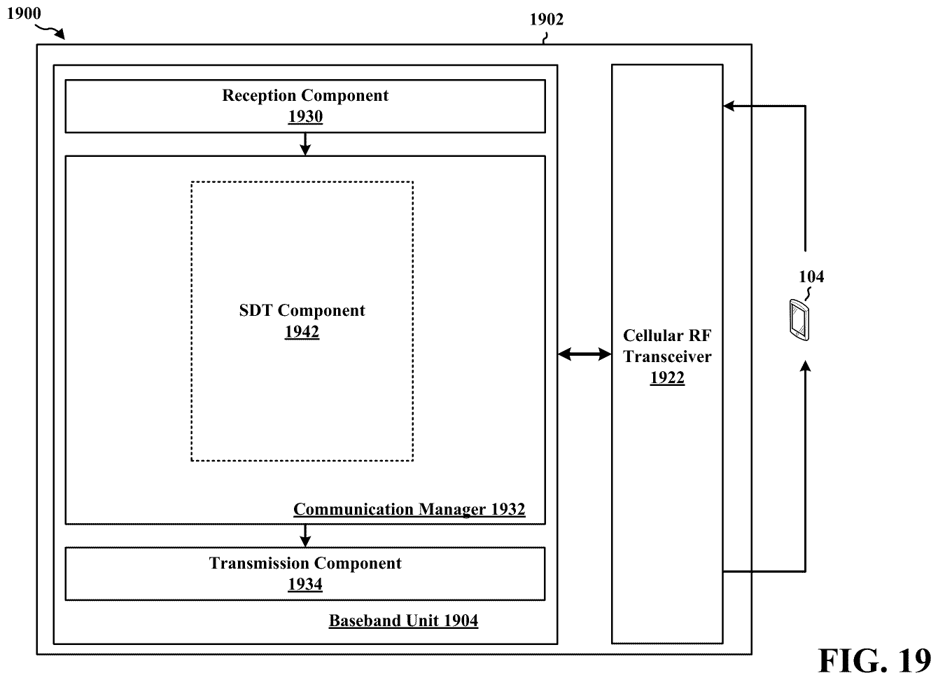

At 1602, the network device may receive, from a UE, a capability indication representing support of MO-SDT and MT-SDT. For example, the base station 904 may receive, from a UE 902, a capability indication 906 representing support of MO-SDT and MT-SDT. In some aspects, 1602 may be performed by SDT component 1942 in FIG. 19.

At 1604, the network device may transmit, to the UE, one or more configurations for the MO-SDT and the MT-SDT in an RRC message, the RRC message including at least an RRC release message. For example, the base station 904 may transmit, to the UE 902, one or more configurations 908 for the MO-SDT and the MT-SDT in an RRC message, the RRC message including at least an RRC release message. In some aspects, 1604 may be performed by SDT component 1942 in FIG. 19. In some aspects, the one or more configurations for the MO-SDT and the MT-SDT may include one or multiple DL RS resources for at least one of one or more RSRP measurements, a TA validation, a link quality evaluation, beam management, power control, positioning, one or more tracking loops, a quasi-colocation, or a spatial relation. In some aspects, the one or more configurations for the MO-SDT and the MT-SDT may include one or more data volume thresholds for an initiation of the MO-SDT and the MT-SDT. In some aspects, the one or more configurations for the MO-SDT and the MT-SDT may include a RSRP threshold associated with selecting the MO-SDT, the MT-SDT, or non-SDT, a beam management, a link quality evaluation, or a TA validation, and a value of the RSRP threshold depends on a type of procedures and one or more UE capabilities associated with the UE. In some aspects, the one or more configurations for the MO-SDT and the MT-SDT include downlink resources in an initial or dedicated DL BWP for the MT-SDT and the MO-SDT, and wherein the one or more configurations for the MO-SDT and the MT-SDT further include uplink resources in an initial or dedicated UL BWP for the MO-SDT and the MT-SDT. In some aspects, the initial or dedicated DL BWP and the initial or dedicated UL BWP are configured based on a UE type or one or more UE capabilities associated with the UE. In some aspects, the initial or dedicated DL BWP and the initial or dedicated UL BWP are independent of a UE type or a UE capability.

At 1606, the UE may transition to an RRC inactive state. For example, the UE 902 may transition to an RRC inactive state at 910. In some aspects, 1606 may be performed by SDT component 1942 in FIG. 19.

At 1608, the network device may receive, from the UE, a CCCH message in a MO-SDT transmission while in the RRC inactive state. For example, the base station 904 may receive, from the UE 902, a CCCH message 912 in a MO-SDT transmission while in the RRC inactive state. In some aspects, 1608 may be performed by SDT component 1942 in FIG. 19.

At 1610, the network device may transmit, to the UE, a response to the CCCH message. For example, the base station 904 may transmit, to the UE 902, a response 914 to the CCCH message 912. In some aspects, 1610 may be performed by SDT component 1942 in FIG. 19. In some aspects, the response is multiplexed with a DCI, an RRC message, or a MAC-CE triggering the MT-SDT for the UE. In some aspects, the response may include DCI scheduling a subsequent UL transmission or a CCCH message retransmission of the UE. In some aspects, the RRC release message is associated with a suspend configuration IE. In some aspects, the one or more configurations for the MO-SDT and the MT-SDT may include radio resource allocation for DL or UL messages belonging to control or data planes.

At 1612, the network device may receive a subsequent UE specific SDT transmission based on receiving the response. For example, the base station 904 may receive a subsequent UE specific SDT transmission (e.g., the subsequent UL transmission 918) based on the response 914. In some aspects, 1612 may be performed by SDT component 1942 in FIG. 19.

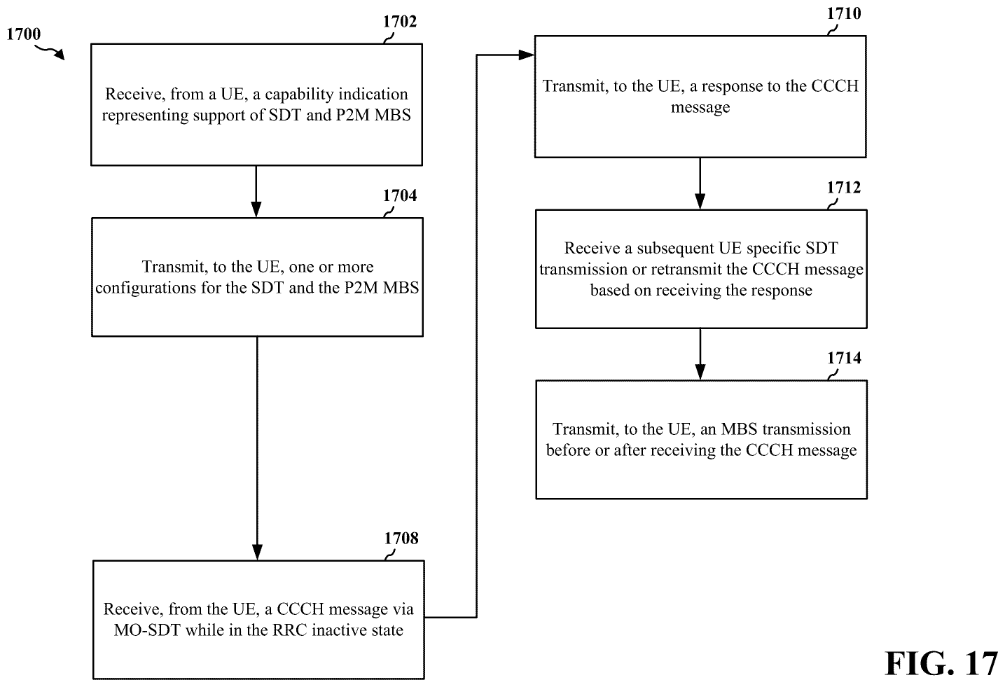

FIG. 17 is a flowchart 1700 of a method of wireless communication. The method may be performed by a UE (e.g., the UE 104, the UE 1002; the apparatus 1802).

At 1702, the network device may receive, from a UE, a capability indication representing support of SDT and P2M MBS. For example, the Base station 1004 may receive, from a UE 1002, a capability indication 1006 representing support of SDT and P2M MBS. In some aspects, 1702 may be performed by SDT component 1842 in FIG. 18.

At 1704, the network device may transmit, to the UE, one or more configurations for the SDT and the P2M MBS in an RRC message, the RRC message including at least an RRC release message. For example, the Base station 1004 may transmit, to the UE 1002, one or more configurations 1008 for the SDT and the P2M MBS in an RRC message, the RRC message including at least an RRC release message. In some aspects, 1704 may be performed by SDT component 1842 in FIG. 18. In some aspects, the one or more configurations for the SDT and the P2M MBS are received/transmitted via an RRC message. In some aspects, the RRC message may include at least an RRC release message associated with a suspend configuration, and the one or more configurations for the SDT and the P2M MBS are received/transmitted via SI or MAC-CE. In some aspects, the one or more configurations for the SDT and the P2M include joint resources in an initial or dedicated DL BWP and an initial or dedicated UL BWP for the SDT or the P2M MBS or separate resources for the SDT or the P2M MBS in the initial or dedicated DL BWP and the initial or dedicated UL BWP. In some aspects, the joint resources or the initial or dedicated DL BWP or the initial or dedicated UL BWP are partitioned based on a UE type or one or more UE capabilities associated with the UE.

At 1708, the network device may receive, from the UE, a CCCH message via MO-SDT while in the RRC inactive state. For example, the Base station 1004 may receive, from the UE 1002, a CCCH message 1012 in a MO-SDT transmission while in the RRC inactive state. In some aspects, 1708 may be performed by SDT component 1842 in FIG. 18.

At 1710, the network device may transmit, to the UE, a response to the CCCH message. For example, the Base station 1004 may transmit, to the UE 1002, a response 1014 to the CCCH message 1012. In some aspects, 1710 may be performed by SDT component 1842 in FIG. 18. In some aspects, the response is multiplexed with a DCI, an RRC message, or a MAC-CE triggering the MT-SDT for the UE. In some aspects, the response may include PDCCH scheduling a P2M MBS transmission, a P2M retransmission, or a P2P retransmission. In some aspects, the response may include DCI scheduling a subsequent UL transmission or a CCCH message retransmission of the UE. In some aspects, the RRC release message is associated with a suspend configuration IE. I

At 1712, the base station may receive a subsequent UE specific SDT transmission based on receiving the response. For example, the base station 1004 may receive a subsequent UE specific SDT transmission (e.g., the subsequent UL transmission 1018). In some aspects, 1712 may be performed by SDT component 1842 in FIG. 18.

At 1714, the network device may transmit, to the UE, an MBS transmission before or after transmitting the CCCH message. For example, the Base station 1004 may transmit, to the UE 1002, an MBS transmission (e.g., MBS data 1016) before or after receiving the CCCH message 1012. In some aspects, 1714 may be performed by SDT component 1842 in FIG. 18.

In some aspects, the network device may receive, from the UE, a HARQ feedback for the MBS transmission based on a valid TA, an unexpired TA timer for the SDT, and the response to the CCCH message. For example, the Base station 1004 may receive, from the UE 1002, a HARQ feedback (e.g., 1017) for the MBS transmission based on a valid TA an unexpired TA timer for the SDT, and the response to the CCCH message.

In some aspects, an initial or dedicated DL BWP is configured via a MIB, an RRC message or a SIB, and the capability indication further represents support of P2P retransmission for multicast associated with the P2M MBS. In some aspects, a UL BWP is configured via an RRC message or a SIB. In some aspects, the capability indication further represents support HARQ feedback to a P2P or P2M retransmission for multicast associated with the P2M MBS, and the HARQ feedback is transmitted on common UL resources for a group of UEs including the UE or dedicated UL resources for the UE. In some aspects, a HARQ feedback to MBS transmission or retransmission is multiplexed with a HARQ feedback to MT-SDT transmission or retransmission and other control information on the common UL resources or the dedicated UL resources. In some aspects, a HARQ feedback to the P2M MBS or a MT-SDT is multiplexed with the MO-SDT transmission or retransmission on a same set common UL resources for a group of UEs including the UE or dedicated UL resources for the UE.

FIG. 18 is a diagram 1800 illustrating an example of a hardware implementation for an apparatus 1802. The apparatus 1802 may be a UE, a component of a UE, or may implement UE functionality. In some aspects, the apparatus 1802 may include a cellular baseband processor 1804 (also referred to as a modem) coupled to a cellular RF transceiver 1822. In some aspects, the apparatus 1802 may further include one or more subscriber identity modules (SIM) cards 1820, an application processor 1806 coupled to a secure digital (SD) card 1808 and a screen 1810, a Bluetooth module 1812, a wireless local area network (WLAN) module 1814, a Global Positioning System (GPS) module 1816, or a power supply 1818. The cellular baseband processor 1804 communicates through the cellular RF transceiver 1822 with the UE 104 and/or BS 102/180. The cellular baseband processor 1804 may include a computer-readable medium/memory. The computer-readable medium/memory may be non-transitory. The cellular baseband processor 1804 is responsible for general processing, including the execution of software stored on the computer-readable medium/memory. The software, when executed by the cellular baseband processor 1804, causes the cellular baseband processor 1804 to perform the various functions described supra. The computer-readable medium/memory may also be used for storing data that is manipulated by the cellular baseband processor 1804 when executing software. The cellular baseband processor 1804 further includes a reception component 1830, a communication manager 1832, and a transmission component 1834. The communication manager 1832 includes the one or more illustrated components. The components within the communication manager 1832 may be stored in the computer-readable medium/memory and/or configured as hardware within the cellular baseband processor 1804. The cellular baseband processor 1804 may be a component of the UE 350 and may include the memory 360 and/or at least one of the TX processor 368, the RX processor 356, and the controller/processor 359. In one configuration, the apparatus 1802 may be a modem chip and include just the baseband processor 1804, and in another configuration, the apparatus 1802 may be the entire UE (e.g., see 350 of FIG. 3) and include the additional modules of the apparatus 1802. The communication manager 1832 includes an SDT component 1842 that may be configured to transmit, to a network entity, a capability indication representing support of MO-SDT and MT-SDT, e.g., as described in connection with 1202 in FIGS. 12 and 1302 in FIG. 13. In some aspects, the SDT component 1842 may be configured to receive, from the network entity, one or more configurations for the MO-SDT and the MT-SDT in an RRC message, the RRC message comprising at least an RRC release message, e.g., as described in connection with 1204 in FIGS. 12 and 1304 in FIG. 13. In some aspects, the SDT component 1842 may be configured to transition to an RRC inactive state, e.g., as described in connection with 1206 in FIGS. 12 and 1306 in FIG. 13. In some aspects, the SDT component 1842 may be configured to transmit, to the network entity, a CCCH message in a MO-SDT transmission while in the RRC inactive state, e.g., as described in connection with 1208 in FIGS. 12 and 1308 in FIG. 13. In some aspects, the SDT component 1842 may be configured to receive, from the network entity, a response to the CCCH message, e.g., as described in connection with 1310 in FIG. 13. In some aspects, the SDT component 1842 may be configured to transmit a subsequent UE specific SDT transmission based on receiving the response, e.g., as described in connection with 1312 in FIG. 13.

In some aspects, the SDT component 1842 may be configured to transmit, to a network entity, a capability indication representing support of SDT and P2M MBS, e.g., as described in connection with 1502 in FIGS. 15 and 1402 in FIG. 14. In some aspects, the SDT component 1842 may be configured to receive, from the network entity, one or more configurations for the SDT and the P2M MBS, e.g., as described in connection with 1504 in FIGS. 15 and 1404 in FIG. 14. In some aspects, the SDT component 1842 may be configured to transition to an RRC inactive state, e.g., as described in connection with 1506 in FIGS. 15 and 1406 in FIG. 14. In some aspects, the SDT component 1842 may be configured to transmit, to the network entity, a CCCH message via MO-SDT while in the RRC inactive state, e.g., as described in connection with 1508 in FIGS. 15 and 1408 in FIG. 14. In some aspects, the SDT component 1842 may be configured to receive, from the network entity, a response to the CCCH message, e.g., as described in connection with 1510 in FIG. 15. In some aspects, the SDT component 1842 may be configured to transmit a subsequent UE specific SDT transmission or retransmit the CCCH message based on receiving the response, e.g., as described in connection with 1512 in FIG. 15. In some aspects, the SDT component 1842 may be configured to receive, from the network entity, an MBS transmission before or after transmitting the CCCH message and transmit HARQ, e.g., as described in connection with 1514 in FIG. 15. In some aspects, the SDT component 1842 may be configured to skip or prioritize, e.g., as described in connection with 1516 in FIG. 15.

The apparatus may include additional components that perform each of the blocks of the algorithm in the flowcharts of FIGS. 12-15. As such, each block in the flowcharts of FIGS. 12-15 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1802 may include a variety of components configured for various functions. In one configuration, the apparatus 1802, and in particular the cellular baseband processor 1804, includes means for transmitting, to a base station, a capability indication representing support of MO-SDT and MT-SDT. The cellular baseband processor 1804 may further include means for receiving, from the base station, one or more configurations for the MO-SDT and the MT-SDT in an RRC message, the RRC message comprising at least an RRC release message. The cellular baseband processor 1804 may further include means for transitioning to an RRC inactive state. The cellular baseband processor 1804 may further include means for transmitting, to the base station, a CCCH message in a MO-SDT transmission while in the RRC inactive state. The cellular baseband processor 1804 may further include means for receiving, from the base station, a response to the CCCH message. The cellular baseband processor 1804 may further include means for transmitting a subsequent UE specific SDT transmission based on receiving the response. The cellular baseband processor 1804 may further include means for transmitting, to a base station, a capability indication representing support of SDT and P2M MBS. The cellular baseband processor 1804 may further include means for receiving, from the base station, one or more configurations for the SDT and the P2M MBS. The cellular baseband processor 1804 may further include means for transitioning to an RRC inactive state. The cellular baseband processor 1804 may further include means for transmitting, to the base station, a CCCH message via MO-SDT while in the RRC inactive state. The cellular baseband processor 1804 may further include means for receiving, from the base station, a response to the CCCH message. The cellular baseband processor 1804 may further include means for transmitting a subsequent UE specific SDT transmission or retransmit the CCCH message based on receiving the response. The cellular baseband processor 1804 may further include means for receiving, from the base station, an MBS transmission before or after transmitting the CCCH message and transmit HARQ. The cellular baseband processor 1804 may further include means for skipping or prioritizing. The means may be one or more of the components of the apparatus 1802 configured to perform the functions recited by the means. As described supra, the apparatus 1802 may include the TX Processor 368, the RX Processor 356, and the controller/processor 359. As such, in one configuration, the means may be the TX Processor 368, the RX Processor 356, and the controller/processor 359 configured to perform the functions recited by the means. FIG. 19 is a diagram 1900 illustrating an example of a hardware implementation for an apparatus 1902. The apparatus 1902 may be a base station, a component of a base station, or may implement base station functionality. In some aspects, the apparatus may be an aggregated base station), or alternatively, by a CU, a DU, an RU, an Near-RT RIC, or a Non-RT RIC in a disaggregated base station architecture. In some aspects, the apparatus 1802 may include a baseband unit 1904. The baseband unit 1904 may communicate through a cellular RF transceiver 1922 with the UE 104. The baseband unit 1904 may include a computer-readable medium/memory. The baseband unit 1904 is responsible for general processing, including the execution of software stored on the computer-readable medium/memory. The software, when executed by the baseband unit 1904, causes the baseband unit 1904 to perform the various functions described supra. The computer-readable medium/memory may also be used for storing data that is manipulated by the baseband unit 1904 when executing software. The baseband unit 1904 further includes a reception component 1930, a communication manager 1932, and a transmission component 1934. The communication manager 1932 includes the one or more illustrated components. The components within the communication manager 1932 may be stored in the computer-readable medium/memory and/or configured as hardware within the baseband unit 1904. The baseband unit 1904 may be a component of the base station 310 and may include the memory 376 and/or at least one of the TX processor 316, the RX processor 370, and the controller/processor 375.

The communication manager 1932 includes an SDT component 1942 that may receive, from a UE, a capability indication representing support of MO-SDT and MT-SDT, e.g., as described in connection with 1602 in FIG. 16. The SDT component 1942 may also transmit, to a UE, one or more configurations for the MO-SDT and the MT-SDT in an RRC message, the RRC message comprising at least an RRC release message, e.g., as described in connection with 1604 in FIG. 16. The SDT component 1942 may also receive, from the UE, a CCCH message in a MO-SDT transmission while in the RRC inactive state, e.g., as described in connection with 1608 in FIG. 16. The SDT component 1942 may also transmit, to the UE, a response to the CCCH message, e.g., as described in connection with 1610 in FIG. 16. The SDT component 1942 may also receive a subsequent UE specific SDT transmission based on receiving the response, e.g., as described in connection with 1612 in FIG. 16. The SDT component 1942 may receive, from a UE, a capability indication representing support of SDT and P2M MBS, e.g., as described in connection with 1702 in FIG. 17. The SDT component 1942 may transmit, to the UE, one or more configurations for the SDT and the P2M MBS, e.g., as described in connection with 1704 in FIG. 17. The SDT component 1942 may receive, from the UE, a CCCH message via MO-SDT while in the RRC inactive state, e.g., as described in connection with 1708 in FIG. 17. The SDT component 1942 may transmit, to the UE, a response to the CCCH message, e.g., as described in connection with 1710 in FIG. 17. The SDT component 1942 may receive a subsequent UE specific SDT transmission or retransmit the CCCH message based on receiving the response, e.g., as described in connection with 1712 in FIG. 17. The SDT component 1942 may transmit, to the UE, an MBS transmission before or after receiving the CCCH message, e.g., as described in connection with 1714 in FIG. 17.

The apparatus may include additional components that perform each of the blocks of the algorithm in the flowcharts of FIGS. 16-17. As such, each block in the flowcharts of FIGS. 16-17 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1902 may include a variety of components configured for various functions. In one configuration, the apparatus 1902, and in particular the baseband unit 1904, includes means for receiving, from a UE, a capability indication representing support of MO-SDT and MT-SDT. The baseband unit 1904 may further include means for transmitting, to a UE, one or more configurations for the MO-SDT and the MT-SDT in an RRC message, the RRC message comprising at least an RRC release message. The baseband unit 1904 may further include means for receiving, from the UE, a CCCH message in a MO-SDT transmission while in the RRC inactive state. The baseband unit 1904 may further include means for transmitting, to the base station, a response to the CCCH message. The baseband unit 1904 may further include means for receiving a subsequent UE specific SDT transmission based on receiving the response. The baseband unit 1904 may further include means for receiving, from a UE, a capability indication representing support of SDT and P2M MBS. The baseband unit 1904 may further include means for transmitting, to the UE, one or more configurations for the SDT and the P2M MBS. The baseband unit 1904 may further include means for receiving, from the UE, a CCCH message via MO-SDT while in the RRC inactive state. The baseband unit 1904 may further include means for transmitting, to the UE, a response to the CCCH message. The baseband unit 1904 may further include means for receiving a subsequent UE specific SDT transmission or retransmit the CCCH message based on receiving the response. The baseband unit 1904 may further include means for transmitting, to the UE, an MBS transmission before or after receiving the CCCH message. The means may be one or more of the components of the apparatus 1902 configured to perform the functions recited by the means. As described supra, the apparatus 1902 may include the TX Processor 316, the RX Processor 370, and the controller/processor 375. As such, in one configuration, the means may be the TX Processor 316, the RX Processor 370, and the controller/processor 375 configured to perform the functions recited by the means.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

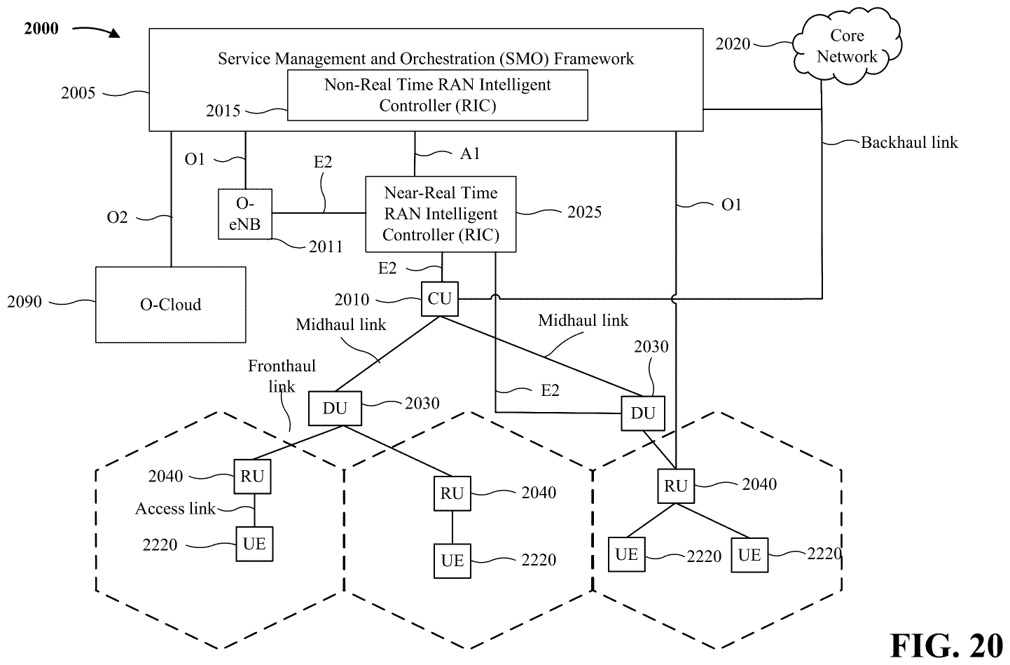

FIG. 20 shows a diagram illustrating an example disaggregated base station 2000 architecture. The disaggregated base station 2000 architecture may include one or more central units (CUs) 2010 that can communicate directly with a core network 2020 via a backhaul link, or indirectly with the core network 2020 through one or more disaggregated base station units (such as a Near-Real Time (Near-RT) RAN Intelligent Controller (RIC) 2025 via an E2 link, or a Non-Real Time (Non-RT) RIC 2015 associated with a Service Management and Orchestration (SMO) Framework 2005, or both). A CU 2010 may communicate with one or more distributed units (DUs) 2030 via respective midhaul links, such as an F1 interface. The DUs 2030 may communicate with one or more radio units (RUs) 2040 via respective fronthaul links. The RUs 2040 may communicate with respective UEs 2220 via one or more radio frequency (RF) access links. In some implementations, the UE 2220 may be simultaneously served by multiple RUs 2040.

Each of the units, i.e., the CUS 2010, the DUs 2030, the RUs 2040, as well as the Near-RT RICs 2025, the Non-RT RICs 2015 and the SMO Framework 2005, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 2010 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 2010. The CU 2010 may be configured to handle user plane functionality (i.e., Central Unit-User Plane (CU-UP)), control plane functionality (i.e., Central Unit-Control Plane (CU-CP)), or a combination thereof. In some implementations, the CU 2010 can be logically split into one or more CU-UP units and one or more CU-CP units. The CU-UP unit can communicate bidirectionally with the CU-CP unit via an interface, such as the E1 interface when implemented in an O-RAN configuration. The CU 2010 can be implemented to communicate with the DU 2030, as necessary, for network control and signaling.

The DU 2030 may correspond to a logical unit that includes one or more base station functions to control the operation of one or more RUs 2040. In some aspects, the DU 2030 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 2030 may further host one or more low PHY layers. Each layer (or module) can be implemented with an interface configured to communicate signals with other layers (and modules) hosted by the DU 2030, or with the control functions hosted by the CU 2010.

Lower-layer functionality can be implemented by one or more RUs 2040. In some deployments, an RU 2040, controlled by a DU 2030, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 2040 can be implemented to handle over the air (OTA) communication with one or more UEs 2220. In some implementations, real-time and non-real-time aspects of control and user plane communication with the RU(s) 2040 can be controlled by the corresponding DU 2030. In some scenarios, this configuration can enable the DU(s) 2030 and the CU 2010 to be implemented in a cloud-based RAN architecture, such as a vRAN architecture.

The SMO Framework 2005 may be configured to support RAN deployment and provisioning of non-virtualized and virtualized network elements. For non-virtualized network elements, the SMO Framework 2005 may be configured to support the deployment of dedicated physical resources for RAN coverage requirements which may be managed via an operations and maintenance interface (such as an O1 interface). For virtualized network elements, the SMO Framework 2005 may be configured to interact with a cloud computing platform (such as an open cloud (O-Cloud) 2090) to perform network element life cycle management (such as to instantiate virtualized network elements) via a cloud computing platform interface (such as an O2 interface). Such virtualized network elements can include, but are not limited to, CUs 2010, DUs 2030, RUs 2040 and Near-RT RICs 2025. In some implementations, the SMO Framework 2005 can communicate with a hardware aspect of a 4G RAN, such as an open eNB (O-cNB) 2011, via an O1 interface. Additionally, in some implementations, the SMO Framework 2005 can communicate directly with one or more RUs 2040 via an O1 interface. The SMO Framework 2005 also may include a Non-RT RIC 2015 configured to support functionality of the SMO Framework 2005.

The Non-RT RIC 2015 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 2025. The Non-RT RIC 2015 may be coupled to or communicate with (such as via an AI interface) the Near-RT RIC 2025. The Near-RT RIC 2025 may be configured to include a logical function that enables near-real-time control and optimization of RAN elements and resources via data collection and actions over an interface (such as via an E2 interface) connecting one or more CUs 2010, one or more DUs 2030, or both, as well as an O-eNB, with the Near-RT RIC 2025.

In some implementations, to generate AI/ML models to be deployed in the Near-RT RIC 2025, the Non-RT RIC 2015 may receive parameters or external enrichment information from external servers. Such information may be utilized by the Near-RT RIC 2025 and may be received at the SMO Framework 2005 or the Non-RT RIC 2015 from non-network data sources or from network functions. In some examples, the Non-RT RIC 2015 or the Near-RT RIC 2025 may be configured to tune RAN behavior or performance. For example, the Non-RT RIC 2015 may monitor long-term trends and patterns for performance and employ AI/ML models to perform corrective actions through the SMO Framework 2005 (such as reconfiguration via O1) or via creation of RAN management policies (such as AI policies).

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.
Aspect 1 is a method for communication at a user equipment (UE), comprising: transmitting, to a base station, a capability indication representing support of mobile-originated small data transmission (MO-SDT) and mobile-terminated small data transmission (MT-SDT); receiving, from the base station, one or more configurations for the MO-SDT and the MT-SDT in a radio resource control (RRC) message, the RRC message comprising at least an RRC release message; transitioning to an RRC inactive state; and transmitting, to the base station, a common control channel (CCCH) message in a MO-SDT transmission while in the RRC inactive state.
Aspect 2 is the method of aspect 1, further comprising: receiving, from the base station, a response to the CCCH message.
Aspect 3 is the method of any of aspects 1-2, further comprising: transmitting a subsequent UE specific SDT transmission based on receiving the response.
Aspect 4 is the method of any of aspects 1-3, wherein the response is multiplexed with a downlink control information (DCI), an RRC message, or a medium access control (MAC) control element (MAC-CE) triggering the MT-SDT for the UE.
Aspect 5 is the method of any of aspects 1-4, wherein the response comprises downlink control information (DCI) scheduling a subsequent uplink (UL) transmission or a CCCH message retransmission of the UE.
Aspect 6 is the method of any of aspects 1-5, wherein the RRC release message is associated with a suspend configuration information element (IE).
Aspect 7 is the method of any of aspects 1-6, wherein the one or more configurations for the MO-SDT and the MT-SDT comprises radio resource allocation for downlink (DL) or uplink (UL) messages belonging to control or data planes.
Aspect 8 is the method of any of aspects 1-7, wherein the one or more configurations for the MO-SDT and the MT-SDT comprises one or multiple downlink reference signal (DL RS) resources for at least one of one or more reference signal received power (RSRP) measurements, a timing advance (TA) validation, a link quality evaluation, beam management, power control, positioning, one or more tracking loops, a quasi-colocation, or a spatial relation.
Aspect 9 is the method of any of aspects 1-8, wherein the one or more configurations for the MO-SDT and the MT-SDT comprises one or more data volume thresholds for an initiation of the MO-SDT and the MT-SDT.
Aspect 10 is the method of any of aspects 1-9, wherein the one or more configurations for the MO-SDT and the MT-SDT comprises a reference signal received power (RSRP) threshold associated with selecting the MO-SDT, the MT-SDT, or non-SDT, a beam management, a link quality evaluation, or a timing advance (TA) validation, and a value of the RSRP threshold depends on a type of procedures and one or more UE capabilities associated with the UE.
Aspect 11 is the method of any of aspects 1-10, wherein the one or more configurations for the MO-SDT and the MT-SDT include downlink resources in an initial or dedicated downlink (DL) bandwidth part (BWP) for the MT-SDT and the MO-SDT, and wherein the one or more configurations for the MO-SDT and the MT-SDT further include uplink resources in an initial or dedicated uplink (UL) BWP for the MO-SDT and the MT-SDT.
Aspect 12 is the method of any of aspects 1-11, wherein the initial or dedicated DL BWP and the initial or dedicated UL BWP are configured based on a UE type or one or more UE capabilities associated with the UE.
Aspect 13 is the method of any of aspects 1-12, wherein the initial or dedicated DL BWP and the initial or dedicated UL BWP are independent of a UE type or a UE capability.
Aspect 14 is a method for communication at a user equipment (UE), comprising: transmitting, to a base station, a capability indication representing support of small data transmission (SDT) and point-to-multi-point (P2M) multicast and broadcast services (MBS); receiving, from the base station, one or more configurations for the SDT and the P2M MBS; transitioning to a radio resource control (RRC) inactive state; and transmitting, to the base station, a common control channel (CCCH) message via mobile-originated SDT (MO-SDT) while in the RRC inactive state.
Aspect 15 is the method of aspect 14, wherein the one or more configurations for the SDT and the P2M MBS are received via an RRC message, wherein the RRC message comprises at least an RRC release message associated with a suspend configuration, and wherein the one or more configurations for the SDT and the P2M MBS are received via system information (SI) or medium access control (MAC) control element (MAC-CE).
Aspect 16 is the method of any of aspects 14-15, wherein the one or more configurations for the SDT and the P2M include: joint resources in an initial or dedicated downlink (DL) bandwidth part (BWP) and an initial or dedicated uplink (UL) BWP for the SDT or the P2M MBS, or separate resources for the SDT or the P2M MBS in the initial or dedicated DL BWP and the initial or dedicated UL BWP.
Aspect 17 is the method of any of aspects 14-16, wherein the joint resources or the initial or dedicated DL BWP or the initial or dedicated UL BWP are partitioned based on a UE type or one or more UE capabilities associated with the UE.
Aspect 18 is the method of any of aspects 14-17, further comprising: receiving, from the base station, a response to the CCCH message.
Aspect 19 is the method of any of aspects 14-18, further comprising: transmitting a subsequent UE specific SDT transmission or retransmit the CCCH message based on receiving the response, wherein the response is multiplexed with a downlink control information (DCI), an RRC message, or medium access control (MAC) control element (MAC-CE) triggering a mobile-terminated small data transmission (MT-SDT) of the UE.
Aspect 20 is the method of any of aspects 14-19, wherein the response comprises downlink control information (DCI) scheduling a subsequent uplink (UL) transmission or CCCH message retransmission of the UE or comprises physical downlink control channel (PDCCH) scheduling a P2M MBS transmission, a P2M retransmission, or a peer to peer (P2P retransmission).
Aspect 21 is the method of any of aspects 14-20, further comprising: receiving, from the base station, an MBS transmission before or after transmitting the CCCH message.
Aspect 22 is the method of any of aspects 14-21, further comprising: transmitting, to the base station, a hybrid automatic repeat request (HARQ) feedback for the MBS transmission based on a valid timing advance (TA), an unexpired TA timer for the SDT, and the response to the CCCH message.
Aspect 23 is the method of any of aspects 14-22, wherein an initial or dedicated downlink (DL) bandwidth part (BWP) is configured via a master information block (MIB), an RRC message or a system information block (SIB), and wherein the capability indication further represents support of peer to peer (P2P) retransmission for multicast associated with the P2M MBS.
Aspect 24 is the method of any of aspects 14-23, wherein a uplink (UL) bandwidth part (BWP) is configured via an RRC message or a system information block (SIB), and wherein the capability indication further represents support hybrid automatic repeat request (HARQ) feedback to a peer to peer (P2P) or P2M retransmission for multicast associated with the P2M MBS, and the HARQ feedback is transmitted on common UL resources for a group of UEs including the UE or dedicated UL resources for the UE.
Aspect 25 is the method of any of aspects 14-24, wherein a hybrid automatic repeat request (HARQ) feedback to MBS transmission or MBS retransmission is multiplexed with a HARQ feedback to MT-SDT transmission or MT-SDT retransmission and other control information on the common UL resources or the dedicated UL resources.
Aspect 26 is the method of any of aspects 14-25, wherein a hybrid automatic repeat request (HARQ) feedback to the P2M MBS or a mobile terminated SDT (MT-SDT) is multiplexed with the MO-SDT transmission or retransmission on a same set common UL resources for a group of UEs including the UE or dedicated UL resources for the UE.
Aspect 27 is the method of any of aspects 14-26, further comprising: skipping, based on at least one of one or more configured rules, a dynamic or semi-persistent priority indication, or a UE capability associated with the UE, a transmission of at least one of: an UL control channel, an UL data channel, an UL RS associated with first hybrid automatic repeat request (HARQ) feedback to the P2M MBS, a second HARQ feedback to an MT-SDT transmission, an MT-SDT retransmission, an MO-SDT transmission, an MO-SDT retransmission, or positioning or channel state feedback based on at least one of one or more configured rules, a dynamic or semi-persistent priority indication, or a UE capability associated with the UE; or skipping, based on at least one of the one or more configured rules, the dynamic or semi-persistent priority indication, a UE power saving specification associated with the UE, or the UE capability associated with the UE, a reception of at least one of: a downlink (DL) control channel, a DL data channel or DL RS associated with a P2M MBS transmission or a P2M MBS retransmission, the MT-SDT transmission or the MT-SDT retransmission, a third HARQ feedback to the MO-SDT transmission, or measurements or positioning.
Aspect 28 is the method of any of aspects 14-27, further comprising: prioritizing a reception of a downlink (DL) control channel, DL data channel, or DL reference signal (RS) or a transmission of uplink (UL) control channel, UL data channel, or UL RS associated with the P2M MBS, a mobile terminated SDT (MT-SDT), the MO-SDT, positioning, or measurements based on the UE not supporting transmit and receive simultaneously and an overlapping or insufficient switching gap between DL and UL, and wherein the prioritization is further based on one or more configured rules, a dynamic or semi-persistent priority indication, a UE power saving specification associated with the UE, or a UE capability associated with the UE.
Aspect 29 is an apparatus of communication comprising a memory comprising instructions and at least one processor coupled to the memory and configured to execute the instructions and cause the apparatus to perform a method in accordance with any of aspects 1-13.
Aspect 30 is an apparatus for communications, comprising means for performing a method in accordance with any aspects 1-13.
Aspect 31 is a computer-readable medium storing computer executable code, where the code when executed by a processor causes the processor to perform a method in accordance with any of aspects 1-13.
Aspect 32 is an apparatus of communication comprising a memory comprising instructions and at least one processor coupled to the memory and configured to execute the instructions and cause the apparatus to perform a method in accordance with any of aspects 14-28.
Aspect 33 is an apparatus for communications, comprising means for performing a method in accordance with any aspects 14-28.
Aspect 34 is a computer-readable medium storing computer executable code, where the code when executed by a processor causes the processor to perform a method in accordance with any of aspects 14-28.

What is claimed is:

1. An apparatus for communication at a user equipment (UE), comprising:
a memory; and
at least one processor coupled to the memory and configured to:
transmit, to a network entity, a capability indication representing support of mobile-originated small data transmission (MO-SDT) and mobile-terminated small data transmission (MT-SDT);
receive, from the network entity, one or more configurations for the MO-SDT and the MT-SDT in a radio resource control (RRC) message, the RRC message comprising at least an RRC release message;
transition to an RRC inactive state; and
transmit, to the network entity, a common control channel (CCCH) message in a MO-SDT transmission while in the RRC inactive state.

2. The apparatus of claim 1, wherein the at least one processor coupled to the memory is further configured to:
receive, from the network entity, a response to the CCCH message.

3. The apparatus of claim 2, wherein the at least one processor coupled to the memory is further configured to:
transmit a subsequent UE specific SDT transmission based on receiving the response.

4. The apparatus of claim 2, wherein the response is multiplexed with a downlink control information (DCI), an RRC message, or a medium access control (MAC) control element (MAC-CE) triggering the MT-SDT for the UE.

5. The apparatus of claim 2, wherein the response comprises downlink control information (DCI) scheduling a subsequent uplink (UL) transmission or a CCCH message retransmission of the UE.

6. The apparatus of claim 1, wherein the RRC release message is associated with a suspend configuration information element (IE).

7. The apparatus of claim 1, wherein the one or more configurations for the MO-SDT and the MT-SDT comprises radio resource allocation for downlink (DL) or uplink (UL) messages belonging to control or data planes.

8. The apparatus of claim 1, wherein the one or more configurations for the MO-SDT and the MT-SDT comprises one or multiple downlink reference signal (DL RS) resources for at least one of one or more reference signal received power (RSRP) measurements, a timing advance (TA) validation, a link quality evaluation, beam management, power control, positioning, one or more tracking loops, a quasi-colocation, or a spatial relation.

9. The apparatus of claim 1, wherein the one or more configurations for the MO-SDT and the MT-SDT comprises one or more data volume thresholds for an initiation of the MO-SDT and the MT-SDT.

10. The apparatus of claim 1, wherein the one or more configurations for the MO-SDT and the MT-SDT comprises a reference signal received power (RSRP) threshold associated with selecting the MO-SDT, the MT-SDT, or non-SDT, a beam management, a link quality evaluation, or a timing advance (TA) validation, and a value of the RSRP threshold depends on a type of procedures and one or more UE capabilities associated with the UE.

11. The apparatus of claim 1, wherein the one or more configurations for the MO-SDT and the MT-SDT include downlink resources in an initial or dedicated downlink (DL) bandwidth part (BWP) for the MT-SDT and the MO-SDT, and wherein the one or more configurations for the MO-SDT and the MT-SDT further include uplink resources in an initial or dedicated uplink (UL) BWP for the MO-SDT and the MT-SDT.

12. The apparatus of claim 11, wherein the initial or dedicated DL BWP and the initial or dedicated UL BWP are configured based on a UE type or one or more UE capabilities associated with the UE.

13. The apparatus of claim 11, wherein the initial or dedicated DL BWP and the initial or dedicated UL BWP are independent of a UE type or a UE capability, and further comprising a transceiver coupled to the at least one processor.

14. An apparatus for communication at a user equipment (UE), comprising:
a memory; and
at least one processor coupled to the memory and configured to:
transmit, to a network entity, a capability indication representing support of small data transmission (SDT) and point-to-multi-point (P2M) multicast and broadcast services (MBS);
receive, from the network entity, one or more configurations for the SDT and the P2M MBS;
transition to a radio resource control (RRC) inactive state; and
transmit, to the network entity, a common control channel (CCCH) message via mobile-originated SDT (MO-SDT) while in the RRC inactive state.

15. The apparatus of claim 14, wherein the one or more configurations for the SDT and the P2M MBS are received via an RRC message, wherein the RRC message comprises at least an RRC release message associated with a suspend configuration, and wherein the one or more configurations for the SDT and the P2M MBS are received via system information (SI) or medium access control (MAC) control element (MAC-CE).

16. The apparatus of claim 14, wherein the one or more configurations for the SDT and the P2M include:
joint resources in an initial or dedicated downlink (DL) bandwidth part (BWP) and an initial or dedicated uplink (UL) BWP for the SDT or the P2M MBS, or
separate resources for the SDT or the P2M MBS in the initial or dedicated DL BWP and the initial or dedicated UL BWP.

17. The apparatus of claim 16, wherein the joint resources or the initial or dedicated DL BWP or the initial or dedicated UL BWP are partitioned based on a UE type or one or more UE capabilities associated with the UE.

18. The apparatus of claim 14, wherein the at least one processor coupled to the memory is further configured to:
receive, from the network entity, a response to the CCCH message.

19. The apparatus of claim 18, wherein the at least one processor coupled to the memory is further configured to:
transmit a subsequent UE specific SDT transmission or retransmit the CCCH message based on receiving the response, wherein the response is multiplexed with a downlink control information (DCI), an RRC message, or medium access control (MAC) control element (MAC-CE) triggering a mobile-terminated small data transmission (MT-SDT) of the UE.

20. The apparatus of claim 18, wherein the response comprises downlink control information (DCI) scheduling a subsequent uplink (UL) transmission or CCCH message retransmission of the UE or comprises physical downlink control channel (PDCCH) scheduling a P2M MBS transmission, a P2M retransmission, or a peer to peer (P2P retransmission).

21. The apparatus of claim 18, wherein the at least one processor coupled to the memory is further configured to:
receive, from the network entity, an MBS transmission before or after transmitting the CCCH message; and
transmit, to the network entity, a hybrid automatic repeat request (HARQ) feedback for the MBS transmission based on a valid timing advance (TA), an unexpired TA timer for the SDT, and the response to the CCCH message.

22. The apparatus of claim 14, wherein the at least one processor coupled to the memory is further configured to perform at least one of:
transmit hybrid automatic repeat request (HARQ) feedback for an P2M MBS transmission and an MT-SDT transmission using a single set of physical uplink control channel (PUCCH) resources,
transmit data or control for the P2M MBS using resources configured for the MO-SDT,
transmit channel state information (CSI) for the P2M MBS using the resources configured for the MO-SDT,
receive a multiplexed transmission comprising the P2M MBS and the MT-SDT;
transmit a request for a software update or a firmware update for the P2M MBS using the resources configured for the MO-SDT,
receive the software update or the firmware update for the P2M MBS using MT-SDT resources,
receive a joint configuration for the P2M MBS and the MO-SDT or the MT-SDT,
receive a reconfiguration for the P2M MBS in the MT-SDT resources, or
receive paging using the MT-SDT resources for retransmission of the P2M MBS.

23. The apparatus of claim 14, wherein an initial or dedicated downlink (DL) bandwidth part (BWP) is configured via a master information block (MIB), an RRC message or a system information block (SIB), and wherein the capability indication further represents additional support of peer to peer (P2P) retransmission for multicast associated with the P2M MBS.

24. The apparatus of claim 14, wherein an uplink (UL) bandwidth part (BWP) is configured via an RRC message or a system information block (SIB), and wherein the capability indication further represents support hybrid automatic repeat request (HARQ) feedback to a peer to peer (P2P) or P2M retransmission for multicast associated with the P2M MBS, and the HARQ feedback is transmitted on common UL resources for a group of UEs including the UE or dedicated UL resources for the UE.

25. The apparatus of claim 24, wherein a hybrid automatic repeat request (HARQ) feedback to MBS transmission or MBS retransmission is multiplexed with a HARQ feedback to MT-SDT transmission or MT-SDT retransmission and other control information on the common UL resources or the dedicated UL resources.

26. The apparatus of claim 14, wherein a hybrid automatic repeat request (HARQ) feedback to the P2M MBS or a mobile terminated SDT (MT-SDT) is multiplexed with the MO-SDT transmission or retransmission on a same set common UL resources for a group of UEs including the UE or dedicated UL resources for the UE.

27. The apparatus of claim 14, wherein the at least one processor coupled to the memory is further configured to:
skip, based on at least one of one or more configured rules, a dynamic or semi-persistent priority indication, or a UE capability associated with the UE, a transmission of at least one of:
an UL control channel,
an UL data channel,
an UL RS associated with first hybrid automatic repeat request (HARQ) feedback to the P2M MBS,
a second HARQ feedback to an MT-SDT transmission, an MT-SDT retransmission, an MO-SDT transmission, an MO-SDT retransmission, or
positioning or channel state feedback; or
skip, based on at least one of the one or more configured rules, the dynamic or semi-persistent priority indication, a UE power saving specification associated with the UE, or the UE capability associated with the UE, a reception of at least one of:
a downlink (DL) control channel,
a DL data channel or DL RS associated with a P2M MBS transmission or a P2M MBS retransmission,
the MT-SDT transmission or the MT-SDT retransmission,
a third HARQ feedback to the MO-SDT transmission, or
measurements or positioning.

28. The apparatus of claim 14, wherein the at least one processor coupled to the memory is further configured to:
prioritize a reception of a downlink (DL) control channel, DL data channel, or DL reference signal (RS) or a transmission of uplink (UL) control channel, UL data channel, or UL RS associated with the P2M MBS, a mobile terminated SDT (MT-SDT), the MO-SDT, positioning, or measurements based on the UE not supporting transmit and receive simultaneously and an overlapping or insufficient switching gap between DL and UL, and wherein a prioritization is further based on one or more configured rules, a dynamic or semi-persistent priority indication, a UE power saving specification associated with the UE, or a UE capability associated with the UE.

29. A method for communication at a user equipment (UE), comprising:
transmitting, to a base station, a capability indication representing support of mobile-originated small data transmission (MO-SDT) and mobile-terminated small data transmission (MT-SDT);
receiving, from the base station, one or more configurations for the MO-SDT and the MT-SDT in a radio resource control (RRC) message, the RRC message comprising at least an RRC release message;
transitioning to an RRC inactive state; and
transmitting, to the base station, a common control channel (CCCH) message in a MO-SDT transmission while in the RRC inactive state.

30. A method for communication at a user equipment (UE), comprising:
transmitting, to a base station, a capability indication representing support of small data transmission (SDT) and point-to-multi-point (P2M) multicast and broadcast services (MBS);
receiving, from the base station, one or more configurations for the SDT and the P2M MBS;
transitioning to a radio resource control (RRC) inactive state; and
transmitting, to the base station, a common control channel (CCCH) message via mobile-originated SDT (MO-SDT) while in the RRC inactive state.
